(19) United States
(12) Patent Application Publication
(10) Pub. No.: US 2012/0242835 A1
(43) Pub. Date: Sep. 27, 2012

(54) IMAGING DEVICE, ON-VEHICLE IMAGING SYSTEM, ROAD SURFACE APPEARANCE DETECTION METHOD, AND OBJECT DETECTION DEVICE

(76) Inventors: Xue Li, Kanagawa (JP); Soichiro Yokota, Tokyo (JP); Hideaki Hirai, Kanagawa (JP)

(21) Appl. No.: 13/514,614

(22) PCT Filed: Dec. 16, 2010
(86) PCT No.: PCT/JP2010/073263

§ 371 Date: Jun. 8, 2012

(30) Foreign Application Priority Data
Dec. 25, 2009 (JP) 2009-295838
Nov. 12, 2010 (JP) 2010-254213

(51) Int. Cl. G06K 9/62; H04N 7/18

(52) U.S. Cl. 348/148; 382/104; 382/103; 348/E07.085

(57) ABSTRACT

An imaging device includes an imaging unit mounted on a vehicle and obtaining a vertically-polarized image and a horizontally-polarized image of a road surface on which the vehicle is running; a polarization ratio image generating unit generating a polarization ratio image and calculating polarization ratio information indicating polarization ratios of pixels of the polarization ratio image based on the vertically-polarized image and the horizontally-polarized image; and a roadside structure detection unit detecting a planar line formed on and partitioning the road surface and/or a roadside structure located adjacent to and at an angle with the road surface based on the polarization ratio information of the polarization ratio image.

### TECHNICAL FIELD

A certain aspect of the present invention relates to an imaging device, an on-vehicle imaging system including the imaging device, a road surface appearance detection method, and an object detection device.

### BACKGROUND ART

There is a vehicle control system that identifies the position of a white line (or a yellow line) on the road using an imaging system including, for example, an on-vehicle camera, and controls the steering to keep the vehicle in a traffic lane and thereby to prevent the vehicle from, for example, crossing the center line and causing a traffic accident such as a collision or sliding off of the road.

In such a vehicle control system, a white line recognition device mounted on the vehicle obtains an image of the road in front of the vehicle using an imaging unit such as a CCD camera and detects a white line based on the fact that a portion of the image corresponding to the white line has a higher luminance level. For example, differential processing and binarization are performed on the image to extract an edge (or a sequence of points indicating the edge) and whether the extracted edge is a white line edge is determined. In a known method, Hough transformation, which is a line detection technique, is performed on the extracted edge to determine the position of a white line.

Japanese Patent Application Publication No. 2010-64531 discloses an imaging system that obtains an image of an area in front of a vehicle via polarization filters arranged in the vertical direction of the vehicle and having different polarization directions. The disclosed imaging system can stably detect a white line even when sunlight is being reflected by the road surface.

An image of a road surface in front of the vehicle obtained by the disclosed imaging system includes multiple scan-line areas corresponding to the polarization filters. A white line detection unit of the imaging system detects a white line on the road surface by detecting scan-line areas where the luminance levels of pixels are greater than a threshold.

Japanese Patent Application Publication No. 11-175702 discloses a white line detection method for stably detecting a line such as a white line in a road image regardless of the running environment or the imaging environment. In the disclosed method, two road images with different exposure levels are obtained. For example, when the vehicle is in a tunnel, a white line is detected by a template matching technique based on the luminance difference using one of the road images with the higher exposure level.

JP11-175702 also discloses a method for preventing misidentification of a puddle as a white line. In this method, a vertically-polarized image and a horizontally-polarized image are taken, the difference between the vertically-polarized image and the horizontally-polarized image is calculated to determine whether incident light is diffuse light or specular reflection light, and specular reflection components caused by a puddle are removed.

With the above method, however, it is necessary to take two images, i.e., a vertically-polarized image and a horizontally-polarized image. If the above method is employed in an automatic sensor system, a mechanism for controlling the rotation of polarization filters is necessary in addition to a camera. Thus, the above method increases the costs of a sensor system.

Thus, with related-art technologies, a white-line detection device typically has a complex configuration. Also, with related-art technologies, increasing the detection accuracy increases the image processing load, and decreasing the image processing load decreases the detection accuracy. Further with related-art technologies, it is difficult to correctly detect a line such as a white line in an imaging environment such as cloudy weather or inside of a tunnel where the intensity of light entering an imaging device becomes insufficient.

For an on-vehicle imaging system, how to accurately detect a white line in a road image is one of the important problems to be solved. However, with related-art technologies, it is difficult to accurately detect the position of a white line, for example, under the following situations:

### (1) When a White Line is in the Shadow

In this case, it is difficult to extract the edge of the white line because the difference in the luminance levels between the white line and the road surface is small.

### (2) When the Road Surface is Backlit and Shining

In this case, it is difficult to extract the edge of the white line because the difference in the luminance levels between the white line and the road surface reflecting the sunlight is small.

### (3) When the Weather is Rainy or Cloudy

In this case, it is difficult to extract the edge of the white line because the difference in the luminance levels between the white line and the road surface is small.

### (4) After the Rain

After the rain, since the road surface is wet and shining and there are puddles on the road surface, it is difficult to extract the edge of the white line.

(5) When there is a Road Shoulder or a Ditch Outside of a White Line

The edge of a road shoulder or a ditch is misidentified as the edge of the white line.

(6) When there is a Repaired Part on a Road

A repaired part of a road is misidentified as a white line.

To safely drive a vehicle on the road, in addition to detecting white lines such as a center line and a sideline of the road (may also include a yellow line such as a NO U-TURN line), it is necessary to correctly detect a road edge, i.e., the boundary between the road and a road edge structure (e.g., a central reserve, a side wall, a curb, a planting, or a bank) that is adjacent to and at an angle with (or at a different elevation from) the road surface.

Generally, a road surface is made of asphalt and has a light reflectance that is very different from the light reflectance of a white line made of a resin material. Therefore, it is possible to detect a white line based on the difference in the luminance levels as described above. However, a roadside structure such as a side wall that is adjacent to and at an angle with the road surface is made of, for example, concrete, brick, earth, or a plant, and normally has a light reflectance similar to that of the road surface. Therefore, compared with a white line, it is difficult to accurately detect a roadside structure.

Particularly in an imaging environment (e.g., during night or in a tunnel) where the intensity of incident light is insufficient, it is more difficult to accurately detect a roadside structure.

Even with the method where the difference between a vertically-polarized image and a horizontally-polarized image is used, it is difficult to improve the accuracy of detecting a road edge because the method is also based on the difference in the luminance levels.

To improve the detection accuracy of a related-art detection method based on the difference in the luminance levels, it is necessary to use a distance-measuring mechanism such as a stereo optical system including multiple cameras. However, this complicates the device configuration and increases the image processing load.

### SUMMARY OF THE INVENTION

In an aspect of this disclosure, there is provided an imaging device including an imaging unit mounted on a vehicle and obtaining a vertically-polarized image and a horizontally-polarized image of a road surface on which the vehicle is running; a polarization ratio image generating unit generating a polarization ratio image and calculating polarization ratio information indicating polarization ratios of pixels of the polarization ratio image based on the vertically-polarized image and the horizontally-polarized image; and a roadside structure detection unit detecting a planar line formed on and partitioning the road surface and/or a roadside structure located adjacent to and at an angle with the road surface based on the polarization ratio information of the polarization ratio image.

Another aspect of this disclosure provides an object detection device obtaining an image of a detection target in an imaging area and detecting an image area corresponding to the detection target in the obtained image. The object detection device includes an imaging unit receiving first polarized light and second polarized light included in reflected light from an object in the imaging area and obtaining a first polarization image of the first polarized light and a second polarization image of the second polarized light, the first polarized light and the second polarized light having different polarization directions; a luminance calculation unit dividing each of the first and second polarization images into processing areas and calculating a combined luminance level indicating the sum of luminance levels of the first and second polarization images for each of the processing areas; a polarization ratio calculation unit calculating a polarization ratio indicating a ratio of a difference between the luminance levels of the first and second polarization images to the combined luminance level for each of the processing areas; a polarization ratio image generating unit generating a polarization ratio image based on the polarization ratios of all the processing areas calculated by the polarization ratio calculation unit; a lane line candidate point detection unit detecting lane line candidate points of a lane line partitioning traffic lanes on a road surface based on the polarization ratios; a road surface shape estimation unit estimating a shape of the road surface based on the polarization ratios; a lane line search area determining unit determining a lane line search area based on the estimated shape of the road surface; and a lane line detection unit detecting the lane line based on the lane line candidate points in the determined lane line search area.

### BRIEF DESCRIPTION OF DRAWINGS

FIG. 1 is a block diagram illustrating a configuration of an on-vehicle imaging system according to an embodiment of the present invention;

FIG. 2 is a flowchart showing a control process;

FIG. 3A is a drawing illustrating a polarization ratio image;

FIG. 3B is a drawing illustrating a scanning process of the polarization ratio image of FIG. 3A;

FIG. 4 is a drawing illustrating points on an expressway with different polarization ratios;

FIG. 5 is a graph showing a relationship between polarization ratios and frequencies;

FIG. 6 is a graph showing polarization ratios in sample images on a rainy day;

FIG. 7 is a graph showing polarization ratios in sample images on a fine day;

FIG. 8 is a flowchart showing a process of detecting a white line edge;

FIG. 9 is a flowchart showing a process of detecting a road edge;

FIG. 10 is a drawing illustrating a scanning process for detecting road edges of a road having two white lines;

FIG. 11 is a drawing illustrating a scanning process for detecting road edges of a road having one white line;

FIGS. 12A and 12B are drawings illustrating a scanning process for detecting road edges of a road having no white line using previous image data;

FIGS. 13A and 13B are drawings illustrating a scanning process for detecting road edges of a road having no white line using polarization ratios at the center of an image;

FIGS. 14A and 14B are drawings illustrating a scanning process for detecting road edges of a road having discontinuous white lines using previous image data;

FIGS. 15A and 15B are drawings illustrating a scanning process for detecting road edges of a road where white lines end in the middle using polarization ratios at the center of an image;

FIG. 16 is a drawing illustrating a scanning process of a road on which a shadow is present;

FIGS. 17A and 17B are photographic images used to describe the difference in contrast between a polarization ratio image and a luminance image;

FIGS. 18A and 18B are drawings showing changes in the polarization ratio according to the elevational angle and the direction of sunlight;

FIG. 19 is a graph used to describe that skylight illuminating a shaded area of a road surface has no incident angle dependence;

FIG. 20A is a polarization ratio image and

FIG. 20B is a monochrome luminance image of a road surface that is backlit and shining;

FIG. 21A is a polarization ratio image and

FIG. 21B is a monochrome luminance image taken on a cloudy day;

FIG. 22A is a polarization ratio image and

FIG. 22B is a monochrome luminance image of a wet road surface after the rain;

FIG. 23A is a polarization ratio image and

FIG. 23B is a monochrome luminance image of a road where a side wall is present outside of a white line;

FIGS. 24A through 24D are drawings illustrating a process of detecting lane lines;

FIG. 25A is a polarization ratio image and

FIG. 25B is a monochrome luminance image of a road surface in front of a vehicle;

FIG. 26 is a polarization ratio image where possible lane line edges are detected;

FIG. 27 is a polarization ratio image where the shape of a road surface is detected by a labeling process;

FIG. 28 is a photographic image where lane line search areas are determined based on the width and the inclination of a road surface;

FIG. 29 is an image where the shapes of lane lines are approximated by performing Hough transformation on detected lane line edges in lane line search areas;

FIG. 30 is a block diagram illustrating a configuration of an on-vehicle imaging system according to another embodiment of the present invention;

FIG. 31 is a flowchart showing a control process;

FIG. 32 is a drawing illustrating an example of an imaging unit;

FIG. 33 is a drawing illustrating another example of an imaging unit;

FIG. 34 is a drawing illustrating another example of an imaging unit;

FIG. 35 is a drawing illustrating another example of an imaging unit;

FIG. 36 is a drawing illustrating another example of an imaging unit;

FIG. 37 is a drawing illustrating another example of an imaging unit;

FIG. 38 is a flowchart showing a process of detecting lane line candidate points;

FIG. 39 is a flowchart showing a process performed by a road surface shape estimation unit;

FIG. 40 is a binarized polarization ratio image where connected components of a road surface are extracted based on the characteristics of the road surface; and

FIG. 41 is a flowchart showing a process of determining the condition of a road surface.

### DESCRIPTION OF EMBODIMENTS

Technologies underlying the present invention are described below.

When light enters the interface between two substances with different refractive indices at an angle, the reflectance of a P-polarized component that is parallel to the incidence plane is different from the reflectance of an S-polarized component that is perpendicular to the incidence plane. The P-polarized component decreases to zero at a certain angle (Brewster's angle) and increases thereafter. Meanwhile, the S-polarized component simply increases.

Since the P-polarized component and the S-polarized component have different reflection properties, the polarization ratio (degree of polarization, polarization difference, or polarization difference ratio) represented by a formula 2 below also varies according to the incident angle and the refractive index.

Polarization ratio=(P-polarized component−S-polarized component)/(P-polarized component+S-polarized component) (Formula 2)

The polarization ratio varies according to the refractive index, the incident angle of light from a light source to an object, and the take-off angle of light from the object to the camera.

Generally, a road surface is made of asphalt. Meanwhile, a roadside structure located adjacent to and at an angle with the road surface is made of a material such as concrete, a plant, or earth that is different from asphalt. Also, planar lines such as white lines formed on the road surface are also made of materials different from asphalt.

Since different materials have different refractive indices, the polarization ratio of the road surface differs from the polarization ratio of a line or a roadside structure. Unlike the luminance difference, the difference in the polarization ratios is not greatly affected by the intensity of incident light. Therefore, it is possible to detect the boundary between the road surface and a line and a road shoulder (road edge) that is the edge of a roadside structure by using a polarization ratio image.

A roadside structure is located adjacent to and at an angle with the road surface. When the normal directions of the surfaces of objects are different, the incident angles of light from a light source to the objects and the take-off angles of light from the objects to the camera also become different. As a result, the polarization ratios become different between the road surface and an adjacent area (roadside structure).

This also indicates that it is possible to detect a road shoulder (road edge) that is the edge (boundary) of a roadside structure adjacent to the road surface by using a polarization ratio image. This method particularly improves the accuracy of detecting the edge of a roadside structure because between the road surface and the roadside structure, there is a difference in the polarization ratios due to the difference in angles in addition to a difference in the polarization ratios due to the difference in materials.

Thus, using a polarization ratio image makes it possible to detect the boundary between the road surface and a line and the boundary between the road surface and a roadside structure based on the differences in materials and angles.

As indicated by the formula 2 above, the polarization ratio is obtained by normalizing the difference between the P-polarized component and the S-polarized component by the sum of the P-polarized component and the S-polarized component. Therefore, using a polarization ratio image makes it possible to detect a road edge even in a dark environment where the luminance difference is small.

Preferred embodiments of the present invention are described below with reference to the accompanying drawings.

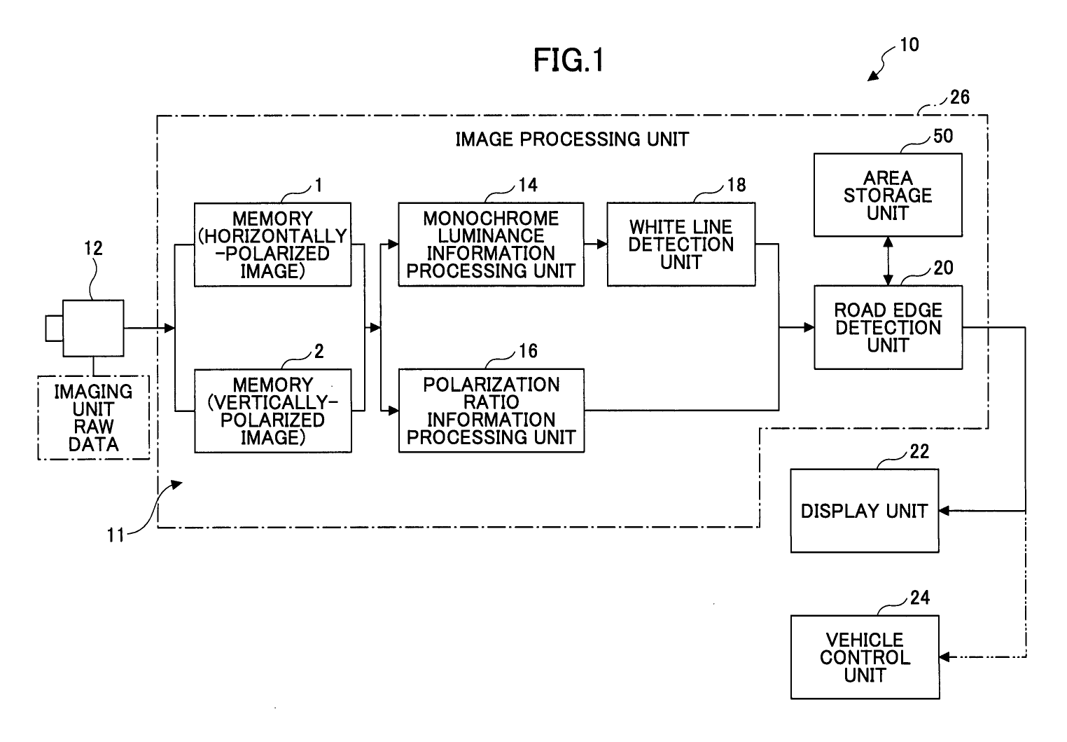

FIG. 1 is a block diagram illustrating a configuration (hardware configuration) of an on-vehicle imaging system 10 according to an embodiment of the present invention.

A polarization camera 12 is mounted on a vehicle and used as an imaging unit. The polarization camera 12 takes an image of the appearance of a road (a scene in front of the vehicle in the running direction, i.e., a front view) on which the vehicle is running and obtains a vertically-polarized component (hereafter called S-component), a horizontally-polarized component (hereafter called P-component), raw polarization image data including the S-component and the P-component.

The obtained horizontally-polarized image data are stored in a memory 1 and the obtained vertically-polarized image data are stored in a memory 2.

The horizontally-polarized image data and the vertically-polarized image data are sent to a monochrome luminance information processing unit 14 used as a luminance information calculation unit and a polarization ratio information processing unit 16 used as a polarization ratio image generating unit. The polarization ratio information processing unit 16 generates a polarization ratio image and calculates polarization ratio information indicating polarization ratios of pixels of the polarization ratio image based on the P-component and the S-component.

The monochrome luminance information processing unit 14 generates a monochrome luminance image and calculates luminance information indicating luminance levels of pixels of the generated monochrome luminance image based on the P-component and the S-component.

The polarization ratio information processing unit 16 calculates polarization ratio information indicating polarization ratios using a formula 1 below and thereby obtains polarization ratio information image data. The polarization ratio indicates the ratio between the polarization components and may be calculated using the formula 2 below.

The polarization ratio information processing unit 16 also generates and outputs luminance information image data using a formula 3 below.

Polarization ratio=P-polarized component/S-polarized component (Formula 1)

Polarization ratio=(P-polarized component−S-polarized component)/(P-polarized component+S-polarized component) (Formula 2)

Luminance data=(P-polarized component+S-polarized component) (Formula 3)

A white line detection unit 18 is used as a line detection unit and detects a white line (white line area) on the road surface based on the luminance information calculated by the monochrome luminance information processing unit 14. A road edge detection unit 20 is used as a roadside structure detection unit and detects a road edge (or a roadside structure) based on white line information obtained by the white line detection unit 18 and polarization ratio information obtained by the polarization ratio information processing unit 16.

The white line detected by the white line detection unit 18 and the road edge detected by the road edge detection unit 20 are displayed on a display unit 22 implemented, for example, by a CRT or liquid crystal display in an easily-viewable manner for the driver. Data obtained by the road edge detection unit 20 may be sent to a vehicle control unit 24 for vehicle control.

The memory 1, the memory 2, the monochrome luminance information processing unit 14, the polarization ratio information processing unit 16, the white line detection unit 18, and the road edge detection unit 20 constitute an image processing unit 26.

The polarization camera 12, the image processing unit 26, and the display unit 22 constitute the on-vehicle imaging system 10. The polarization camera 12 and the image processing unit 26 constitute an imaging device 11.

In the on-vehicle imaging system 10 of this embodiment, all of the polarization camera 12, the image processing unit 26, and the display unit 22 may be installed on the vehicle. Alternatively, only the polarization camera 12 may be installed on the vehicle, and the image processing unit 26 and the display unit 22 may be installed in a remote place so that a person other than the driver can objectively monitor the running conditions of the vehicle.

The polarization camera 12 of this embodiment is configured to be able to take both a horizontally-polarized image and a vertically-polarized image. Alternatively, a polarization camera for taking a horizontally-polarized image and a polarization camera for taking a vertically-polarized image may be provided separately.

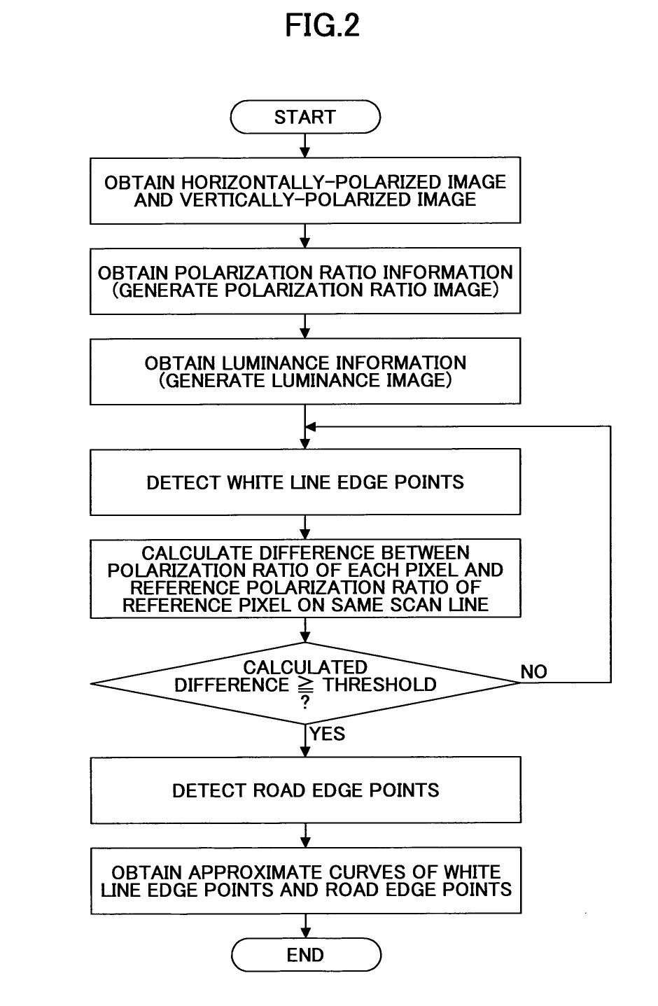

Operations of the on-vehicle imaging system 10 are described below with reference to FIG. 2.

A horizontally-polarized image (P-component), a vertically-polarized image (S-component), and raw polarization image data including the P-component and the S-component of a road surface in front of the vehicle are obtained by the polarization camera 12. Next, polarization ratio information (polarization ratio image) and luminance information (luminance image) are obtained based on the P-component, the S-component, and the raw polarization image data using the formulas 2 and 3 shown above.

An edge of a white line (white line edge) is detected based on the obtained luminance information according to a method described later. The polarization ratios of pixels (reference pixels) inside of the detected white line are set as reference polarization ratios for scanning, and the polarization ratio image is scanned based on the reference polarization ratios. Respective pixels constituting the polarization ratio image have polarization ratios. The road edge detection unit 20 scans, with a beam, each line of pixels (scan line) of the polarization ratio image generated by the polarization ratio information processing unit 16. A scan line indicates a horizontal row of pixels (from the left end to the right end) on a display to be scanned by an electron beam.

Pixels on each scan line are processed sequentially in the right and left directions. The polarization ratio of a pixel on the same scan line as a reference pixel is compared with the corresponding reference polarization ratio. If the difference between the polarization ratio of the pixel and the reference polarization ratio is less than a predetermined threshold, the next pixel on the same scan line is processed. Meanwhile, if the difference is greater than or equal to the threshold, the pixel is detected as a point indicating the road edge (road edge point).

In this embodiment, the polarization ratios of pixels (reference pixels) inside of the white line are used as the reference polarization ratios for scanning to reduce the influence of a shadow generated, for example, by a preceding vehicle, a roadside tree, or a building and thereby to prevent misidentification of the road edge. Alternatively, the polarization ratios of pixels at the center of respective scan lines (at the center of the polarization image) may be used as the reference polarization ratios to detect the road edge.

When detecting the white line edge and the road edge, scan lines are processed (scanned) from the bottom of an image (screen) where the image is more reliable to the top of the image (i.e., in the x-axis direction or the vertical direction of the screen).

After points (white line edge points) indicating the white line edge and points (road edge points) indicating the road edge in one screen (image) are detected, approximate curves of the white line edge points and the road edge points are obtained by shape approximation. The approximate curves are obtained by the road edge detection unit 20 that also functions as an approximate curve obtaining unit.

For example, the least-squares method, the Hough transformation, or a model equation may be used for shape approximation. When obtaining the approximate curves by shape approximation, higher weights are given to reliable white line edge points and road edge points that are detected in a lower part of the road image (or screen). With this method, even if white line edge points and road edge points are detected incorrectly in an upper part of the road image, it is possible to appropriately identify a white line and a road edge as long as white line edge points and road edge points are detected correctly in a lower part of the road image.

When detecting a white line and a road edge in real time, it is determined that the detected white line and road edge are reliable if a similar white line and a similar road edge are found in one or more previously-obtained frames or images (polarization images). Based on the position of the white line in a previous frame, the white line edge and the road edge are searched for in a next frame and lines are drawn. If the position of the white line edge and the position of the road edge are not detected in five frames of images, the search is started again from the center of a scan line in the lower part of an image. The detection results may be used for vehicle control or used to display a white line and a road edge on a display in an easily-viewable manner for the driver.

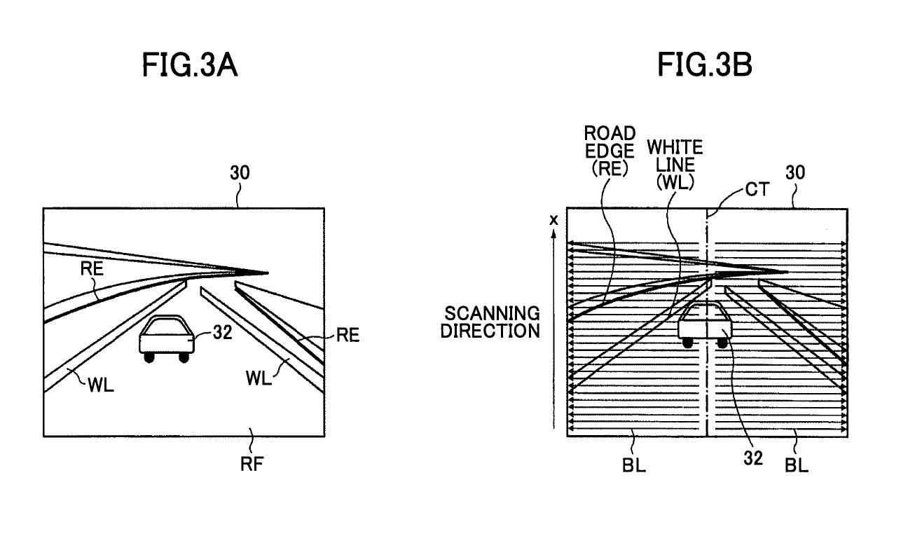

A scanning process for detecting white lines and road edges is described below with reference to FIGS. 3A and 3B.

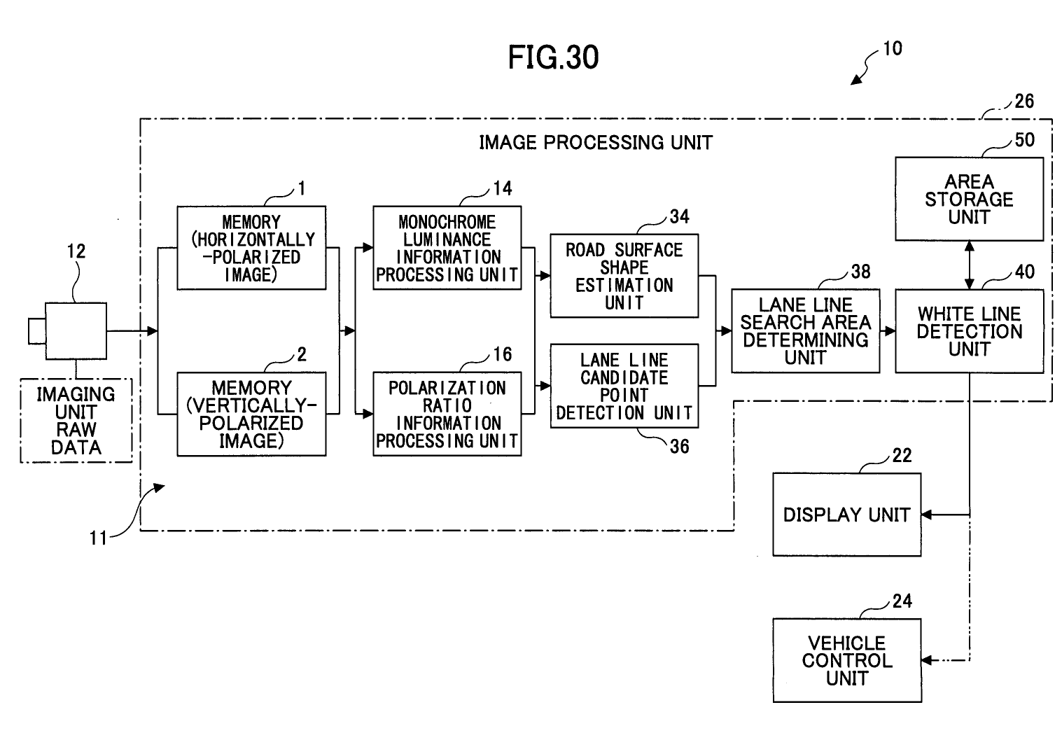

When detecting white line edges and road edges, scan lines BL are processed (scanned) in the x-axis direction (scanning direction) from the bottom of an image where the image is more reliable to the top of the image. As shown in FIG. 3B, pixels are processed from a center CT of each scan line to the right and left ends of the image to detect white lines WL and road edges RE at the right and left sides of a road surface RF. In FIGS. 3A and 3B, 30 indicates a display surface and 32 indicates a vehicle.

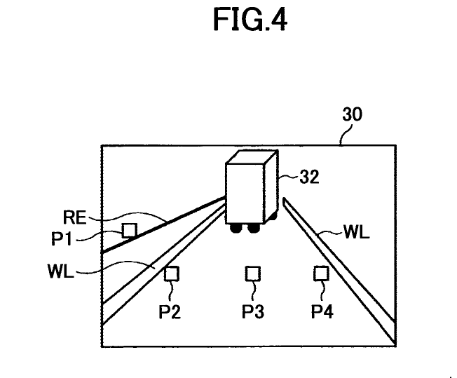

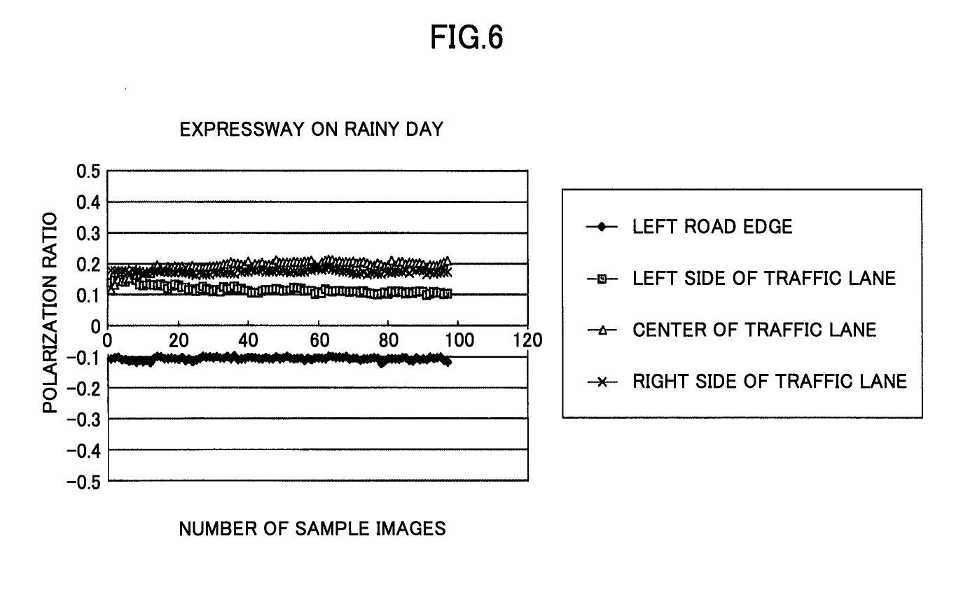

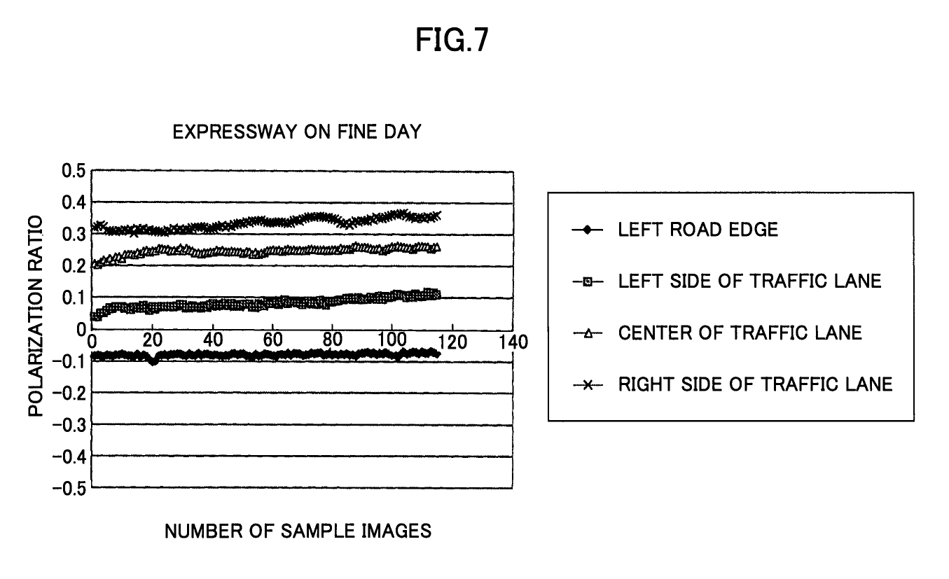

Polarization ratios of 100 sample images are described below with reference to FIGS. 4 through 7. FIG. 4 shows an image of a road surface of an expressway. As shown in FIGS. 6 and 7, on a rainy day and a fine day, polarization ratios in an area (road edge area) at the left road edge RE differ greatly from polarization ratios in an area (road surface area) inside of the left white line WL. Thus, the polarization ratios in the road edge area and the road surface area are different from each other.

This makes it possible to detect a line that is made of a material different from the material of the road surface and a roadside structure located at an angle with the road surface that are not detectable using a monochrome luminance image.

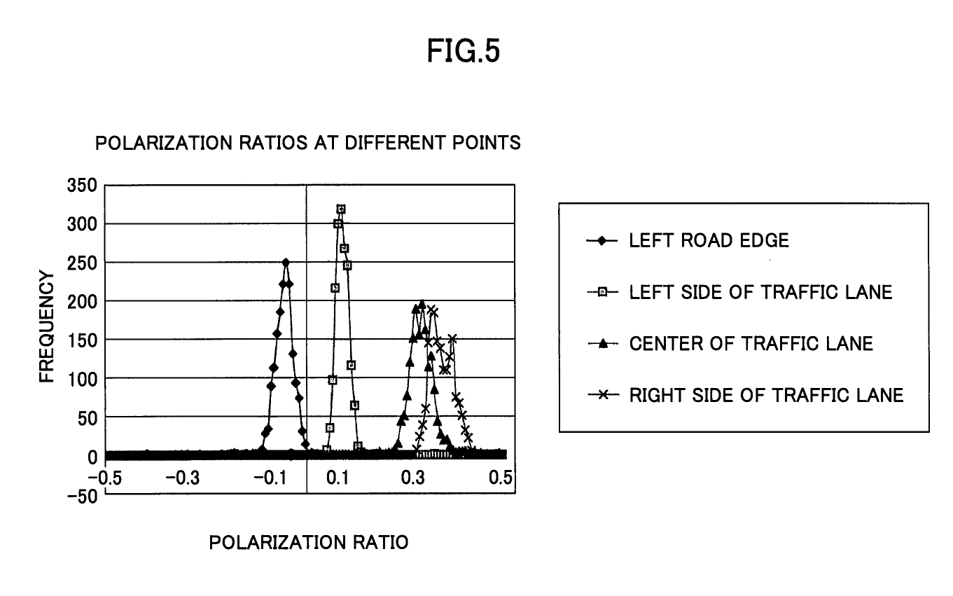

FIG. 5 is a graph showing polarization ratios at P1 (a point at the left road edge), P2 (a point inside of and near the left white line, i.e., on the left side of the traffic lane), P3 (a point at the center of the traffic lane), and P4 (a point inside of and near the right white line, i.e., on the right side of the traffic lane) shown in FIG. 4.

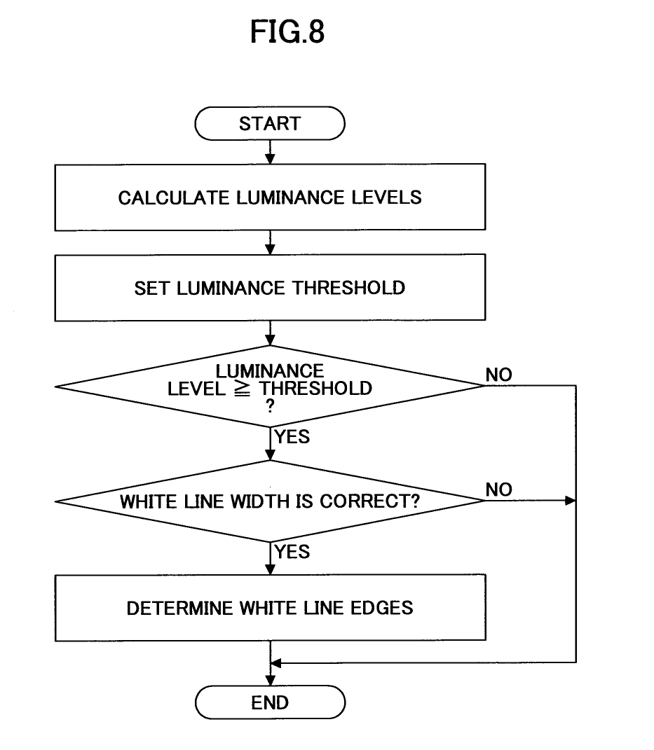

A process of detecting a white line edge is described below with reference to FIG. 8.

A normal road includes a black part made of asphalt and a white line formed on the black part. Therefore, the luminance level of the white line is sufficiently greater than the luminance levels of other parts of the road and the white line can be detected by determining a part of the road with a luminance level greater than a predetermined value.

As shown in FIG. 8, luminance information (luminance levels) of an image of a road surface in front of the vehicle is obtained based on the P-component and the S-component. Using a luminance image generated by the monochrome luminance information processing unit 14, the white line detection unit 18 compares luminance data of the road surface with a predetermined luminance threshold and thereby detects candidate points indicating possible white line edges (white line candidate points). Next, a white line width is calculated based on the detected white line candidate points and whether the calculated white line width is within a predetermined range is determined. If the calculated white line width is within the predetermined range, the white line candidate points are determined as a pair of white line edges on the road surface.

The contrast between the white line and other parts of the road surface in an upper part of the image is different from that in a lower part of the image. Therefore, one frame of the image is divided into an upper area (an area farther from the vehicle in the running direction) and a lower area (an area closer to the vehicle in the running direction) in the x-axis direction, and in a luminance threshold setting step, different luminance thresholds are set for the upper area and the lower area.

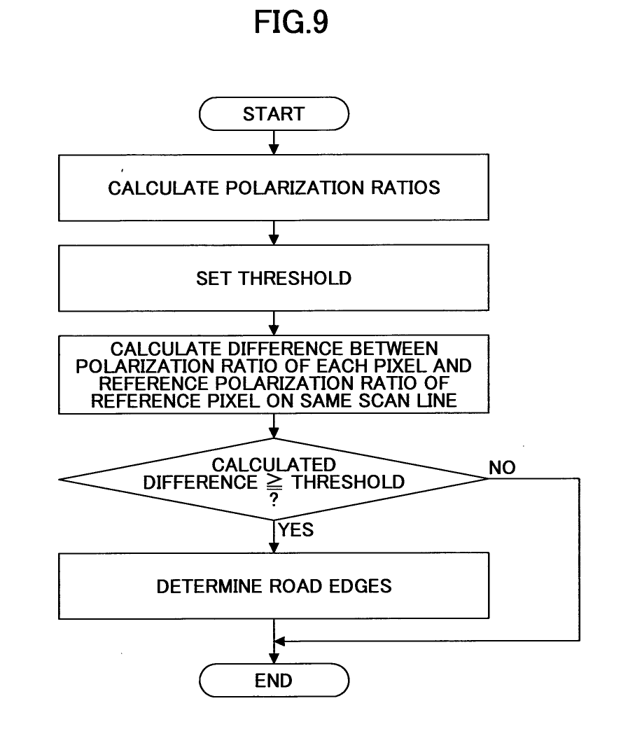

A process of detecting a road edge is described below with reference to FIG. 9.

As described above, a polarization ratio image is generated and reference polarization ratios are determined. Also, a threshold(s) may be determined based on the reference polarization ratios. Here, the polarization ratios of pixels (reference pixels) inside of the detected white line are used as the reference polarization ratios.

In each scan line, pixels on the left side of the image are processed sequentially from the inside of the white line to the left end of the image and pixels on the right side of the image are processed sequentially from the inside of the white line to the right end of the image. The polarization ratio of a pixel on the same scan line as a reference pixel is compared with the corresponding reference polarization ratio and the difference between the polarization ratio of the pixel and the reference polarization ratio is obtained.

Then, the difference is compared with the threshold. If the difference is greater than or equal to the threshold, the pixel is detected as a road edge point.

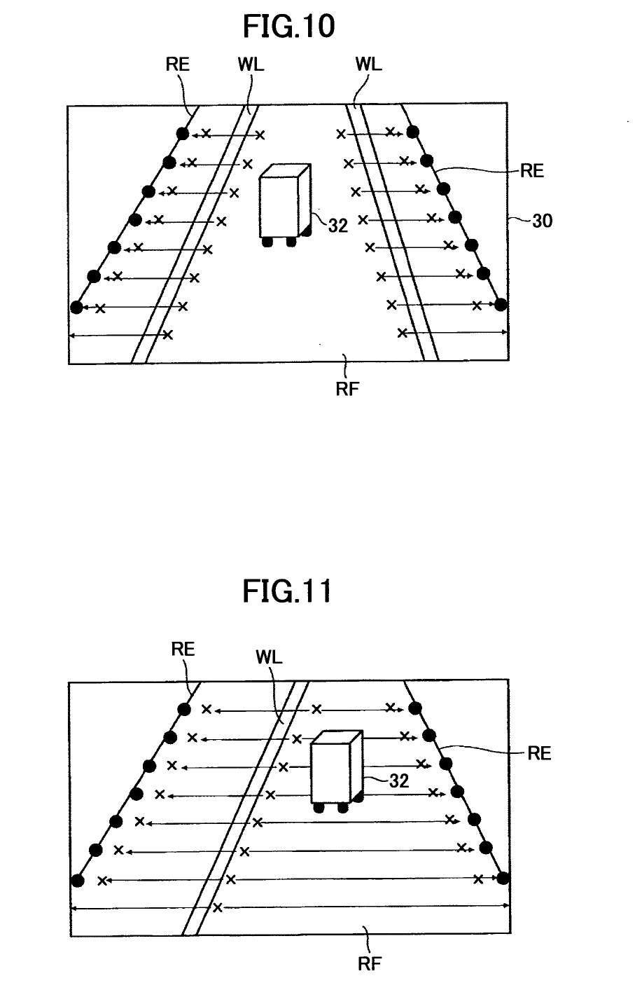

A method of detecting a road edge based on white line information is described in more detail with reference to FIGS. 10 through 16.

FIG. 10 is a drawing illustrating a scanning process for detecting road edges RE of a road having two white lines WL. In the case of FIG. 10, polarization ratios of pixels (reference pixels) inside of the respective white lines WL are used as reference polarization ratios for scanning. Pixels on each scan line are processed sequentially from the center to the right and left ends, and scan lines are processed sequentially from the bottom to the top of the screen. The difference between the reference polarization ratio of a reference pixel and the polarization ratio of each pixel on the same scan line as the reference pixel is calculated, and the difference is compared with a predetermined threshold to detect the road edge (point).

In FIG. 10 (and also FIGS. 11 through 16), “X” indicates a pixel where the difference is less than the threshold and “” indicates a pixel where the difference is greater than or equal to the threshold, i.e., a pixel detected as a road edge point.

FIG. 11 is a drawing illustrating a scanning process for detecting road edges RE of a road having one white line WL. In the case of FIG. 11, polarization ratios of pixels (reference pixels) inside of the white line WL are used as reference polarization ratios for scanning. Pixels on each scan line are processed sequentially in the right and left directions, and scan lines are processed sequentially from the bottom to the top of the screen. Similarly to FIG. 10, the difference between the reference polarization ratio of a reference pixel and the polarization ratio of each pixel on the same scan line as the reference pixel is calculated, and the difference is compared with a predetermined threshold to detect the road edge (point).

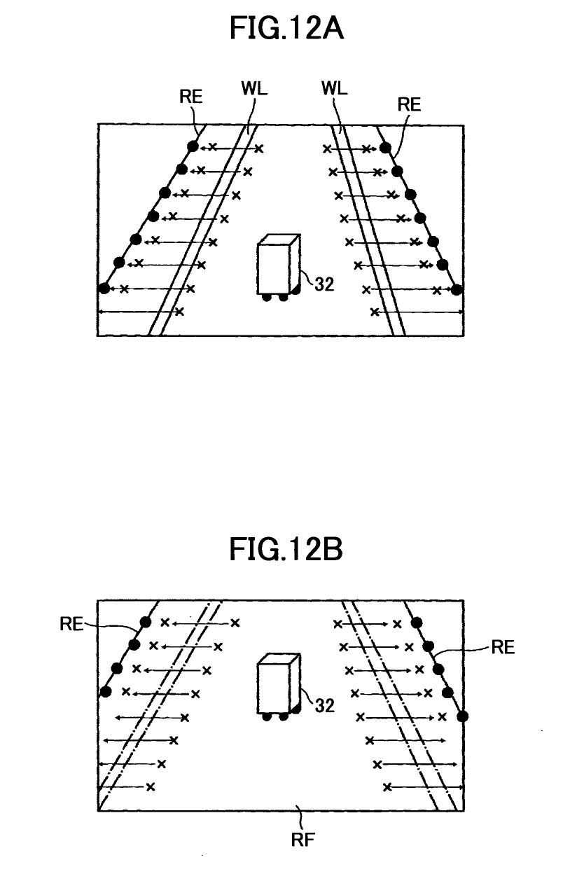

FIGS. 12A and 12B are drawings illustrating a scanning process for detecting road edges of a road when no white line is detected. When no white line is detected in a current image (current frame) as shown in FIG. 12B, the polarization ratios of pixels inside of white lines (indicated by dashed-dotted lines in FIG. 12B) detected in a previous image (immediately preceding frame) shown by FIG. 12A are used as reference polarization ratios to detect road edges.

Areas of white lines and road edges detected in the previous image are stored in an area storage unit 50 (see FIG. 1). The road edge detection unit 20, which also functions as a search position determining unit, determines search positions in the current frame where the road edges or the white lines are to be searched for based on the information stored in the area storage unit 50.

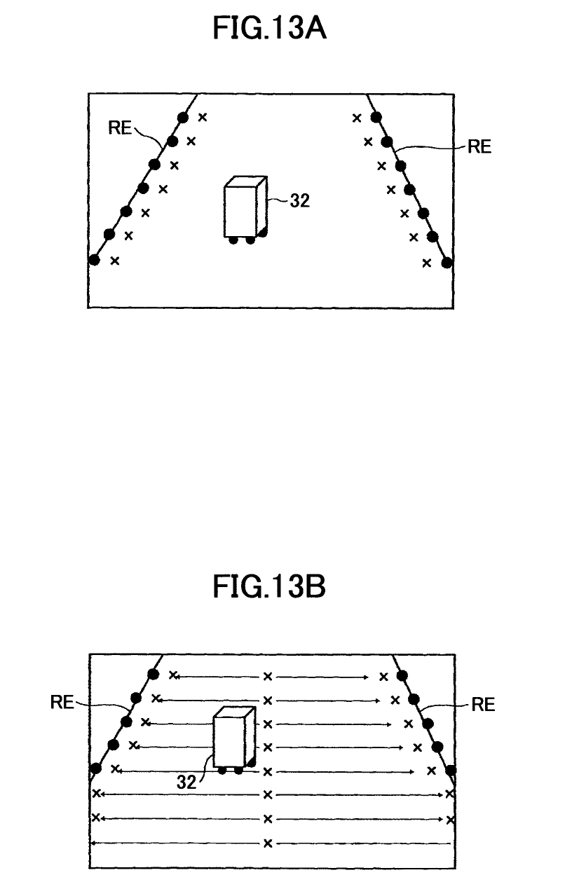

FIGS. 13A and 13B are drawings illustrating a scanning process for detecting road edges of a road when no white line is detected both in the current image and the previous image (immediately preceding frame). In this case, polarization ratios of pixels (reference pixels) at the center of respective scan lines (at the center of the image or screen) are used as reference polarization ratios for scanning. Pixels on each scan line are processed sequentially from the center to the right and left ends, and scan lines are processed sequentially from the bottom to the top of the screen. The difference between the reference polarization ratio of a reference pixel and the polarization ratio of each pixel on the same scan line as the reference pixel is calculated, and the difference is compared with a predetermined threshold to detect the road edge (point).

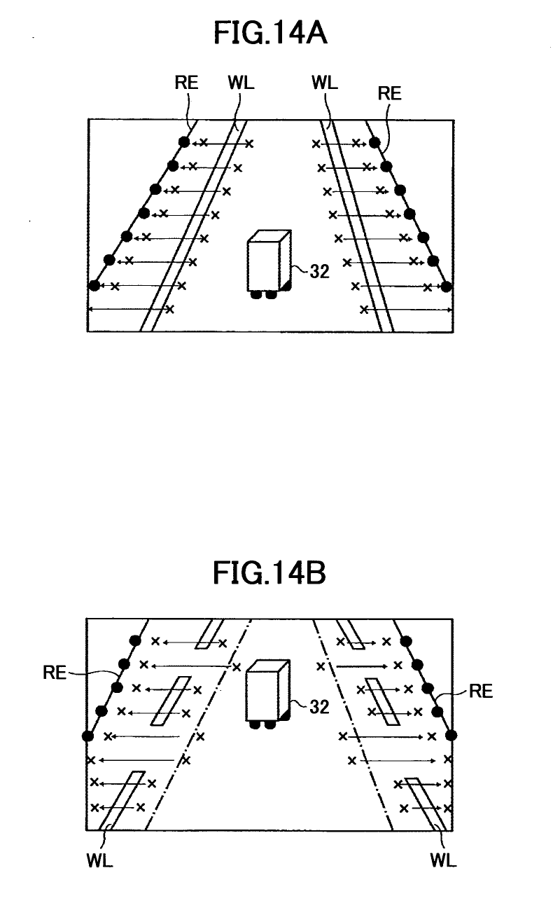

FIGS. 14A and 14B are drawings illustrating a scanning process for detecting road edges of a road having discontinuous white lines. When discontinuous white lines are detected in a current image (current frame) as shown in FIG. 14B, the polarization ratios of pixels inside of white lines (indicated by dashed-dotted lines in FIG. 14B) detected in a previous image (immediately preceding frame) shown by FIG. 14A are used as reference polarization ratios for the parts (scan lines) of the current image where white lines are not present.

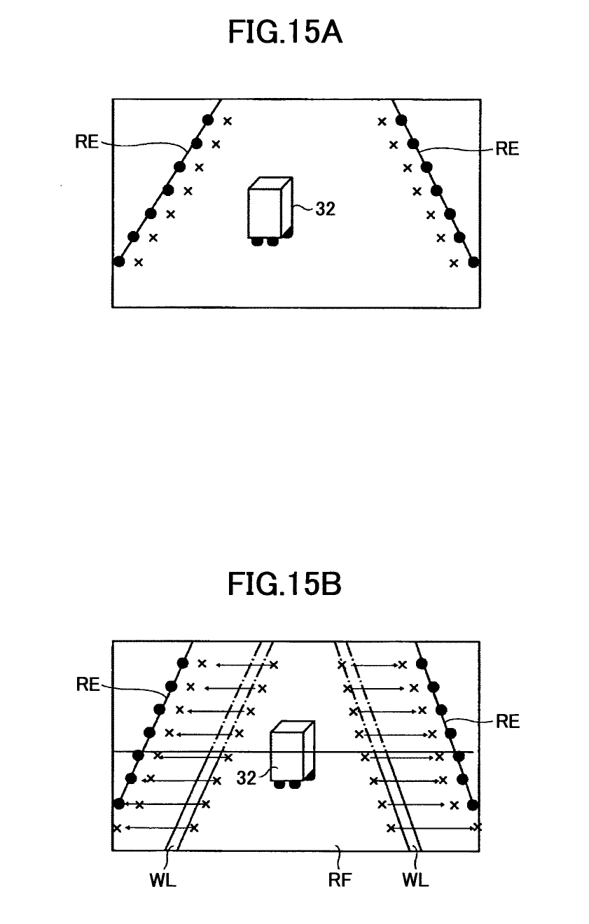

FIGS. 15A and 15B are drawings illustrating a scanning process for detecting road edges of a road where white lines end in the middle. When detected white lines end in the middle in a current image (current frame) as shown in FIG. 15B, the polarization ratios of pixels inside of white lines detected in a previous image (immediately preceding frame) are used as reference polarization ratios. When detected white lines end in the middle in a current image (current frame) and no white line is detected even in a previous image (immediately preceding frame) as shown in FIG. 15A, the polarization ratios of pixels inside of extensions (indicated by dashed-dotted lines in FIG. 15B) of the detected white lines are used as reference polarization ratios for the parts (scan lines) of the current image where white lines are not present.

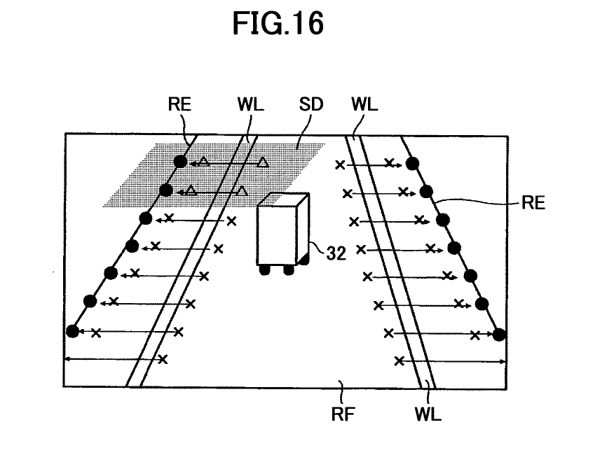

FIG. 16 is a drawing illustrating a scanning process of a road on which a shadow is present.

In FIG. 16, an area inside of a left white line WL and an area next to a left road edge RE are both in a shadow SD.

In this case, since the intensity of incident light decreases due to the shadow SD and the luminance difference between the road surface and the roadside (roadside structure) becomes small, it is difficult to detect the road edge based on the luminance difference. Meanwhile, although polarization ratios are affected by the shadow, the difference between polarization ratios at given points in the shadow is unchanged.

Therefore, it is possible to correctly detect a road edge in the shadow by using the polarization ratios of pixels that are inside of the left white line (that is also in the shadow) as reference polarization ratios.

In this embodiment, the white line detection unit 18 detects white lines based on luminance information. Alternatively, white lines may be detected by the road edge detection unit 20 in a manner similar to the road edge detection methods described above by using, for example, the polarization ratios of pixels (polarization ration information) at the center of an image as reference polarization ratios.

In this case, the monochrome luminance information processing unit 14 and the white line detection unit 18 shown in FIG. 1 may be omitted.

Next, embodiments of the present invention are described in more detail with reference to photographic images.

The contrast of a luminance image and the contrast of a polarization ratio image vary depending on the weather and whether the road surface is in the sun or in the shadow. Also, whether a luminance image or a polarization ratio image is suitable for detecting a line such as a white line depends on the scene (or the imaging environment).

Through various experiments, the inventors found out that there are scenes that are not suitable for a luminance image but suitable for a polarization ratio image and vice versa, i.e., that they are complementary to each other.

In embodiments of the present invention, either a luminance image (luminance information) or a polarization ratio image (polarization ratio information) is used depending on the scene (or the imaging environment) to accurately detect white lines.

Below, exemplary scenes where it is difficult to accurately detect white lines based on luminance information are described. Photographic images used in the descriptions below were taken by the same imaging device mounted on a vehicle and configured to take images in front of the vehicle.

### [1. When a White Line is in the Shadow]

In this case, it is difficult to extract a white line edge because the difference in the luminance levels between the white line and the road is small.

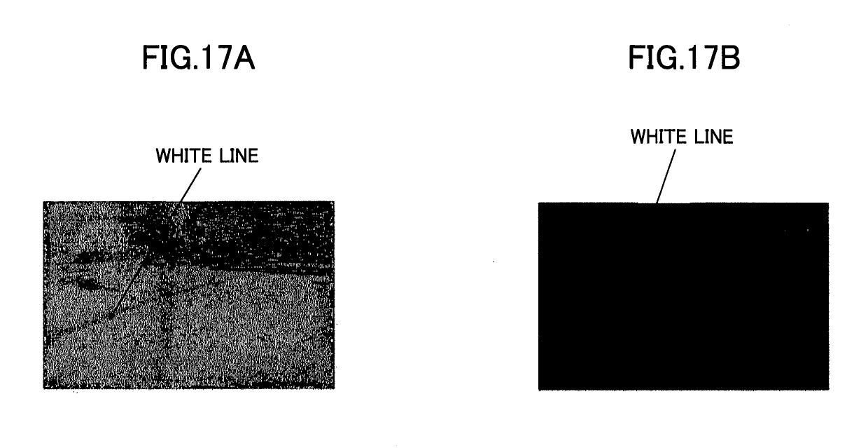

FIG. 17A is a polarization ratio image of a scene where the white line is in the shadow on a fine day, and FIG. 17B is a monochrome luminance image of the same scene. Apparently, compared with the monochrome luminance image of FIG. 17B, the white line can be more clearly identified in the polarization ratio image of FIG. 17A.

The reason of the difference in contrast between a luminance image and a polarization ratio image is described below.

As is apparent from our daily life, the contrast of luminance of a scene in the sun during daytime is high and the contrast of luminance of a scene in the shadow or in reduced illumination on a rainy or cloudy day is low. Meanwhile, the polarization ratio is not visible and the reason why the contrast of polarization varies is not self-explanatory.

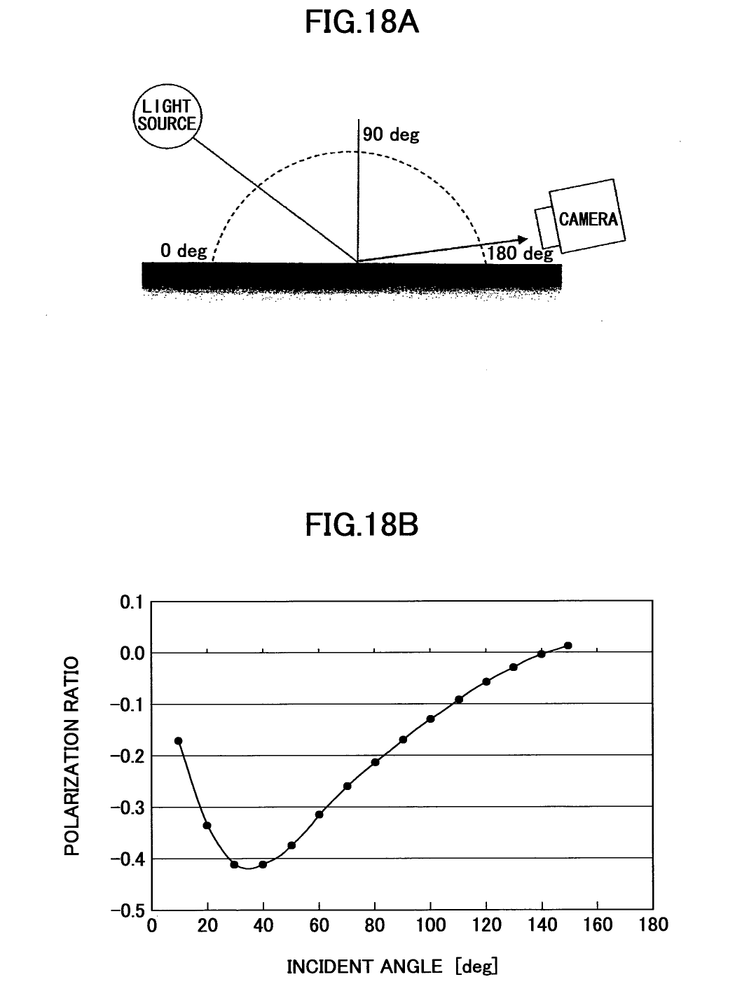

FIG. 18B is a graph showing changes in the polarization ratio between a P-polarized image and an S-polarized image of an asphalt surface that were taken in a laboratory by a fixed camera while changing the position of a light source as shown in FIG. 18A. In the graph, the horizontal axis indicates the incident angle (light source position) and the vertical axis indicates the polarization ratio. The angle of elevation of the camera is about 10 degrees from the horizontal plane. The polarization ratio was calculated from luminance information of the center portions of the P-polarized image and the S-polarized image taken at each incident angle. In FIG. 18B, the polarization ratio indicates the ratio of a value obtained by subtracting an S-polarized component (Rs) from a P-polarized component (Rp) to the sum of the S-polarized component and the P-polarized component.

When the P-polarized component is greater than the S-polarized component, the polarization ratio takes a positive value. Meanwhile, when the S-polarized component is greater than the P-polarized component, the polarization ratio takes a negative value.

The polarization ratio image of FIG. 17A of a scene in the shadow is explained based on the results shown in FIG. 18B.

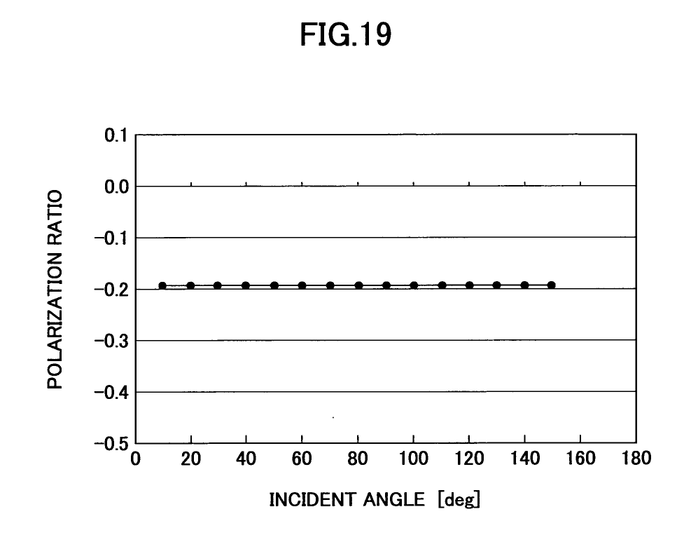

The light source illuminating a road surface and a roadside structure in the shadow is not the direct sunlight but is the skylight (light from the sky). In the case of the sunlight, the polarization ratio changes according to the elevational angle and the direction of the sunlight. Meanwhile, the skylight illuminates the road surface and the roadside structure uniformly from all elevational angles and directions. Therefore, in the case of the skylight, as shown in FIG. 19, the polarization ratio takes a substantially constant value (that corresponds to an average of the values shown in FIG. 18B) regardless of the incident angle.

Also, since a white line is generally made of a coating material including a scatterer, the polarization ratio of the white line is close to zero regardless of the incident angle. Therefore, a polarization ratio image of a road surface and a white line in the shadow has high contrast. Thus, while the contrast of a luminance image of a shady area is low, the contrast of a polarization ratio image of a shady area is high. Accordingly, it is preferable to use a polarization ratio image to detect a white line in a shady area.

### [2. When the Road Surface is Backlit and Shining]

In this case, it is difficult to extract a white line edge because the difference in the luminance levels between the white line and the road surface reflecting the sunlight is small.

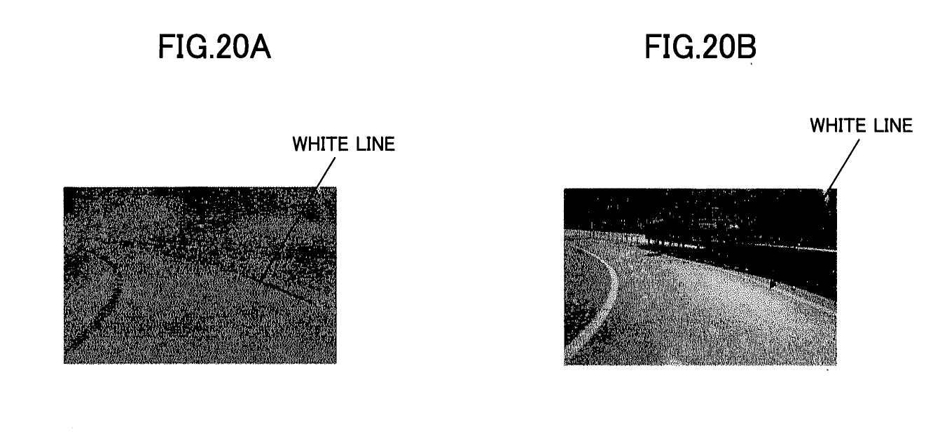

FIG. 20A is a polarization ratio image and FIG. 20B is a monochrome luminance image of a scene on a fine day. Compared with the monochrome luminance image of FIG. 20B, the white line and the road edge can be more clearly identified in the polarization ratio image of FIG. 20A.

On a fine day, although the road surface in the sun is illuminated by both the sunlight and the skylight (the sunlight is a scattered-light component), the sunlight is the dominant component of light illuminating the road surface. Therefore, the results shown in FIG. 18B can be applied to this case.

As shown in FIG. 18B, the polarization ratio increases in the negative direction when the road surface is backlit. When the sun (light source) is behind the camera, the polarization ratio of the asphalt surface is zero. Meanwhile, since a white line is generally made of a coating material including a scatterer, the polarization ratio of the white line is close to zero regardless of the incident angle. Therefore, a polarization ratio image of a backlit road surface and white line has high contrast. When a road surface and a white line are backlit, the intensity of reflected light from the road surface increases and the difference in the luminance levels between the road surface and the white line in a luminance image becomes small. Meanwhile, the contrast of a polarization ratio image is still high even in this case. Accordingly, it is preferable to use a polarization ratio image to detect a white line on a backlit road surface.

### [3. When the Weather is Rainy or Cloudy]

In this case, it is difficult to extract a white line edge because the difference in the luminance levels between the white line and the road is small.

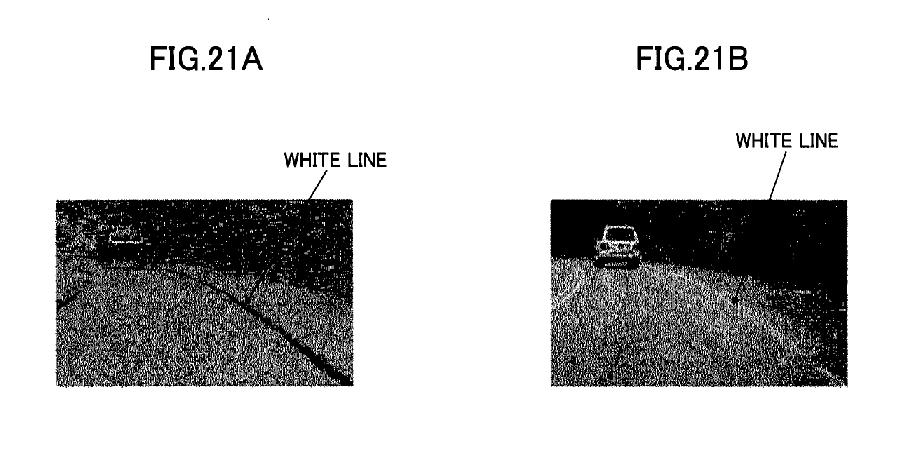

FIG. 21A is a polarization ratio image and FIG. 21B is a monochrome luminance image of a scene on a cloudy day. Compared with the monochrome luminance image of FIG. 21B, the white line can be more clearly identified in the polarization ratio image of FIG. 21A.

Similarly to a scene in the shadow, the light source illuminating the road surface and the white line on a rainy or cloudy day is not the direct sunlight. Therefore, a polarization ratio image of a road surface and a white line on a rainy or cloudy day has high contrast. Thus, while the contrast of a luminance image of a scene on a rainy or cloudy day is low, the contrast of a polarization ratio image of a scene on a rainy or cloudy day is high. Accordingly, it is preferable to use a polarization ratio image to detect a white line on a rainy or cloudy day.

### [4. After the Rain]

After the rain, since the road is wet and shining and there are puddles on the road, it is difficult to extract a white line edge.

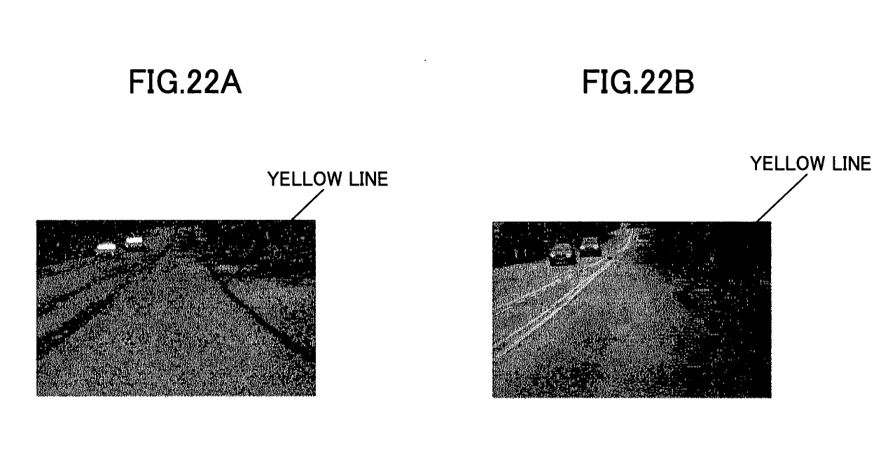

When the road is wet, the specular component increases and it becomes difficult to identify a white line in a luminance image. Also, when the road is wet, the luminance image becomes dark overall and its contrast becomes low. Meanwhile, with a polarization ratio image, it is possible to remove the specular component and to obtain road surface information in a lower layer. Thus, it is preferable to use a polarization ratio image to detect a white line (or yellow line) on a wet road. FIG. 22A is a polarization ratio image and FIG. 22B is a monochrome luminance image of a wet road surface after the rain

[5. When there is a Road Shoulder or a Ditch Outside of a White Line]

The edge of a road shoulder or a ditch may be misidentified as a white line edge.

As described above, with polarization ratio information, it is possible to determine the difference in materials and the difference in angles of objects. For example, with a polarization ratio image, it is possible to obtain angular information based on the fact that orthogonal specular reflection surfaces have opposite polarization ratios. This is not possible with a monochrome luminance image.

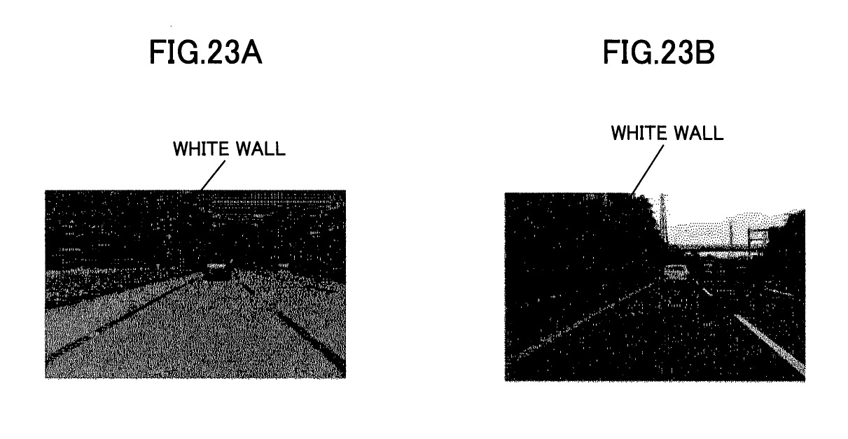

FIG. 23A is a polarization ratio image and FIG. 23B is a monochrome luminance image of a road where a side wall is present outside of a white line. In the monochrome luminance image of FIG. 23B, it is difficult to distinguish between the white line and the side wall. Meanwhile, in the polarization ratio image of FIG. 23A, it is possible to distinguish between the white line and the side wall.

[6. When there is a Repaired Part on a Road

A repaired part of a road may be misidentified as a white line.

The reflection property of an asphalt surface as shown in FIG. 18B varies depending on the conditions of the asphalt surface, for example, whether the asphalt surface is new or old. Therefore, the polarization ratio of a repaired part (new asphalt surface) of a road differs from the polarization ratio of other parts (old asphalt surface) of the road. Thus, using a polarization ratio image makes it possible to differentiate a repaired part of a road from a white line and thereby makes it possible to accurately detect the white line.

As described above, on a rainy or cloudy day or in a shady area where the road surface is not being illuminated by the direct sunlight, the contrast of a luminance image becomes low. Meanwhile, the contrast of a polarization ratio image is high even in such a situation and is not affected by the imaging direction. Therefore, using a polarization ratio image for such a situation makes it possible to reliably detect objects (such as a white line and a road edge) on a road. A polarization ratio image is also preferably used to detect objects in the sun on a fine day, particularly when the objects are backlit.

Meanwhile, a monochrome luminance image is preferably used when objects are illuminated by a light source behind the camera. Thus, in this embodiment, either a luminance image (luminance information) or a polarization ratio image (polarization ratio information) is used depending on the scene (or the imaging environment) to accurately detect white lines.

Another embodiment of the present invention is described below.

First, a method of detecting a lane line (e.g., a white line or a yellow line) on a road surface of this embodiment is described. In this embodiment, candidate points of lane lines (lane line candidate points) are detected using an edge image of a polarization ratio image, lane line search areas are determined based on the shape (the width and the inclination) of the road surface estimated using the polarization ratio image, and the lane lines are detected using the lane line candidate points in the lane line search areas.

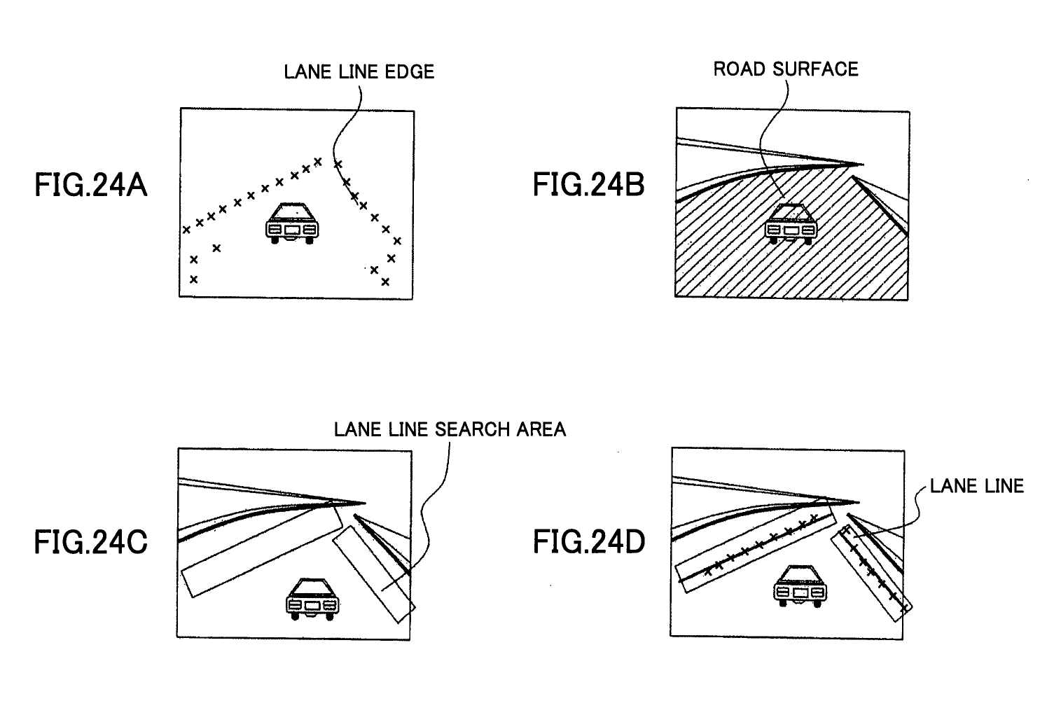

As shown in FIG. 24A, possible lane line edges on the road surface are detected using an edge image of a polarization ratio image. Next, as shown in FIG. 24B, a labeling process is performed on the polarization ratio image to identify the road surface and roadside structures and thereby to estimate the shape (the width and the inclination) of the road surface.

Next, as shown in FIG. 24C, lane line search areas are determined based on the estimated width and inclination of the road surface. Then, as shown in FIG. 24D, the shapes of the lane lines are approximated by performing Hough transformation on the detected lane line edges in the lane line search areas.

An exemplary process according to the above method is described below using actual photographic images.

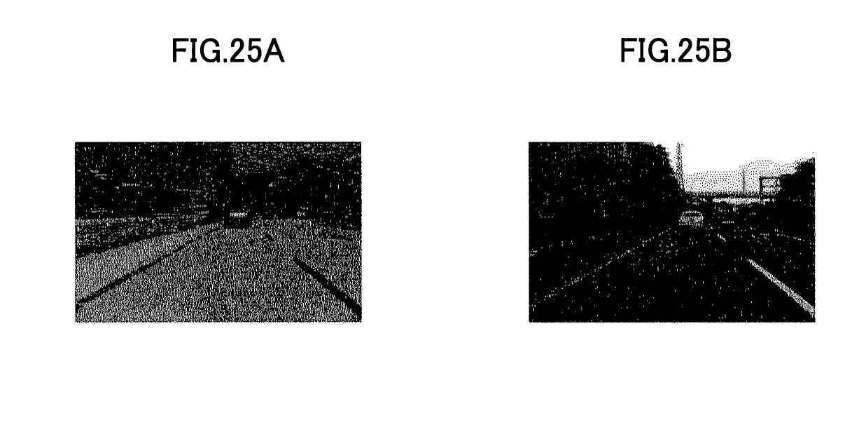

FIG. 25A is a polarization ratio image and FIG. 25B is a monochrome luminance image of a road surface in front of a vehicle.

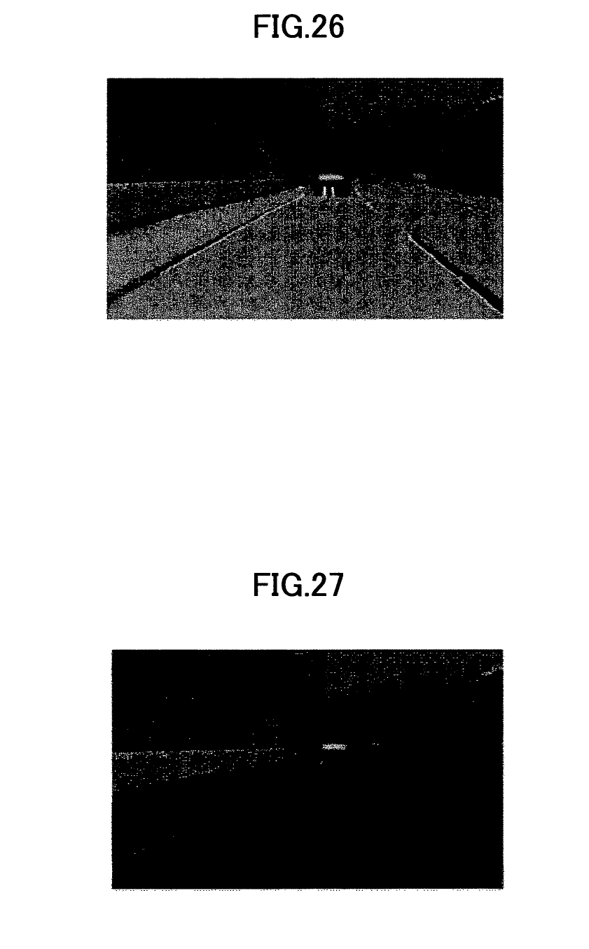

First, possible lane line edges are detected using the polarization ratio image. FIG. 26 shows the detected lane line edges.

Next, the shape (the width and the inclination) of the road surface is estimated by performing a labeling process on the polarization ratio image. FIG. 27 shows the detection results.

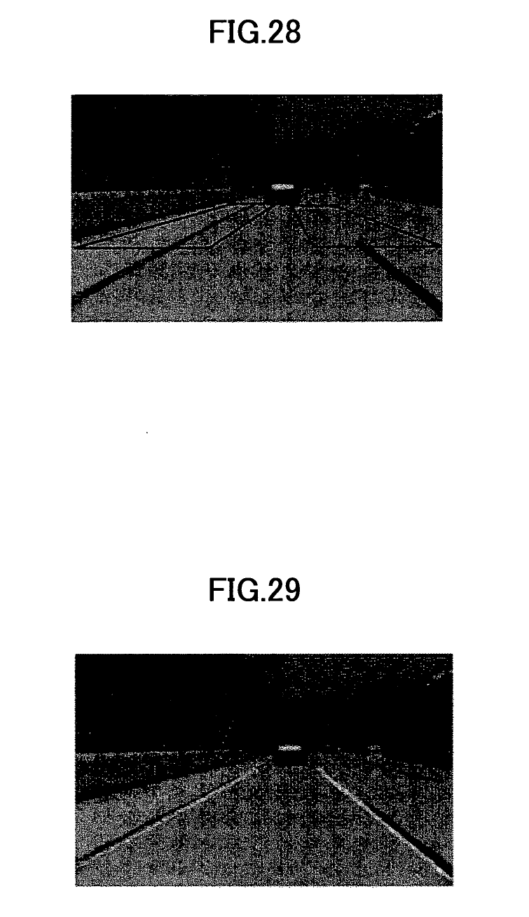

Next, lane line search areas are determined based on the width and the inclination of the road surface (the distance between right and left black lines and the inclinations of the black lines). FIG. 28 shows the determined lane line search areas.

Then, the shapes of the lane lines are approximated by performing Hough transformation on the detected lane line edges in the lane line search areas. FIG. 29 shows the results.

With a process using a monochrome luminance image as shown by FIG. 23B, a white wall on the left side may be misidentified as a white line and it is difficult to detect a white line edge when the luminance difference between the white line and the road surface is small. Meanwhile, with a process using a polarization ratio image as describe above with reference to FIGS. 25 through 29, it is possible to prevent these problems.

An on-vehicle imaging system 10 of this embodiment is described below with reference to FIGS. 30 through 35. The same reference numbers as those shown in FIG. 1 are assigned to the corresponding components in FIG. 30.

As shown in FIG. 30, an image processing unit 26 of the on-vehicle imaging system 10 includes a memory 1, a memory 2, a monochrome luminance information processing unit 14, a polarization ratio information processing unit 16, a road surface shape estimation unit 34, a lane line candidate point detection unit 36, a lane line search area determining unit 38, a lane line detection unit 40, and an area storage unit 50.

A polarization camera 12, the image processing unit 26, and a display unit 22 constitute the on-vehicle imaging system 10. The polarization camera 12 and the image processing unit 26 constitute an object detecting device (imaging device) 11.

A horizontally-polarized component (P-polarized component), a vertically-polarized component (S-polarized component), and raw polarization image data including the P-polarized component and the S-polarized component of a road surface in front of the vehicle are obtained by the polarization camera (imaging unit) 12. Polarization ratio information and monochrome luminance information are obtained from the P-polarized component, the S-polarized component, and the raw polarization image data. The road surface and white lines are detected based on the obtained polarization ratio information according to a method described later.

In this embodiment, the image processing unit 26 also functions as a condition determining unit, a parameter threshold determining unit, and an object detection unit; and the area storage unit 50 also functions as a shape information storage unit and a detection result storage unit.

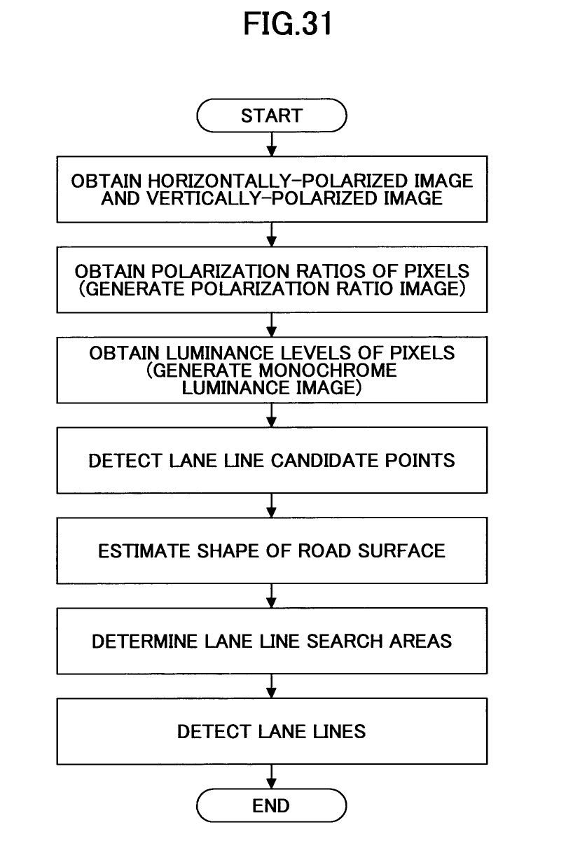

Operations of the on-vehicle imaging system 10 are described with reference to FIGS. 30 and 31.

The imaging unit (polarization camera) 12 includes an image sensor (light-receiving device) such as a charge-coupled device (CCD) or a complementary metal oxide semiconductor (CMOS) and obtains, for example, a megapixel image of a scene including the road surface.

The imaging unit 12 may be mounted on the rearview mirror of a vehicle to take an image of a road surface in front of the vehicle, or may be mounted on a wing mirror to take an image of a road surface at the side of the vehicle. Also, the imaging unit 12 may be mounted on the rear door to take an image of a road surface behind the vehicle.

In this embodiment, the imaging unit 12 is configured to be able to obtain a polarization ratio image in addition to a luminance image. Exemplary configurations of the imaging unit 12 that can obtain a polarization ratio image are described below. However, the imaging unit 12 may have any other appropriate configurations.

### [Exemplary Configuration 1]

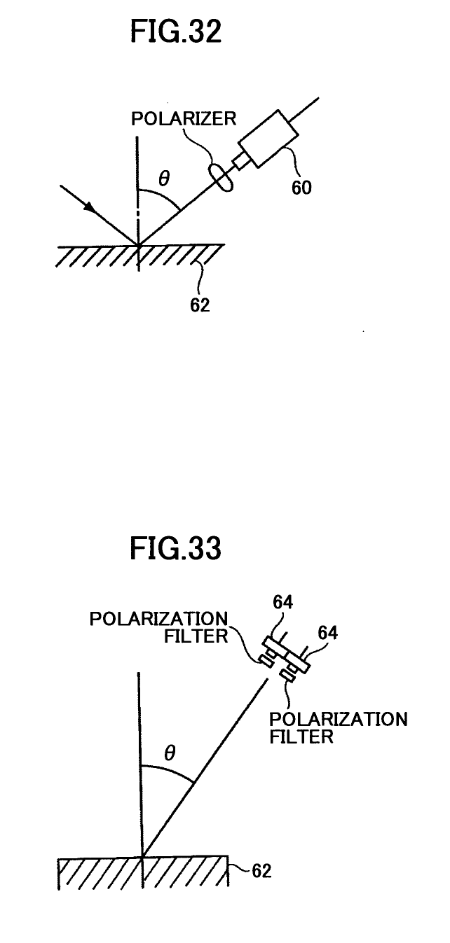

As shown in FIG. 32, the imaging unit 12 may include a camera 60 and a rotatable polarizer provided in front of the camera 60. The imaging unit 12 takes a vertically-polarized image and a horizontally-polarized image of an object 62 by rotating the polarizer and generates a polarization ratio image from the vertically-polarized and horizontally-polarized images.

### [Exemplary Configuration 2]

As shown in FIG. 33, the imaging unit 12 may include a camera 64 that includes a polarization filter disposed to transmit vertically-polarized light and obtains a vertically-polarized image, and a camera 64 that includes a polarization filter disposed to transmit horizontally-polarized light and obtains a horizontally-polarized image.

With the configuration 1 described above, the vertically-polarized image and the horizontally-polarized image are taken at slightly different timings because the polarizer is rotated. Meanwhile, with the configuration 2, it is possible to take the vertically-polarized image and the horizontally-polarized image at the same time.

### [Exemplary Configuration 3]

The imaging unit 12 may include a lens array, a polarization filter array, and one light-receiving device (image sensor). Compared with the configuration 2 where separate two cameras are used (stereo type), the configuration 3 makes it possible to reduce the size of the imaging unit 12.

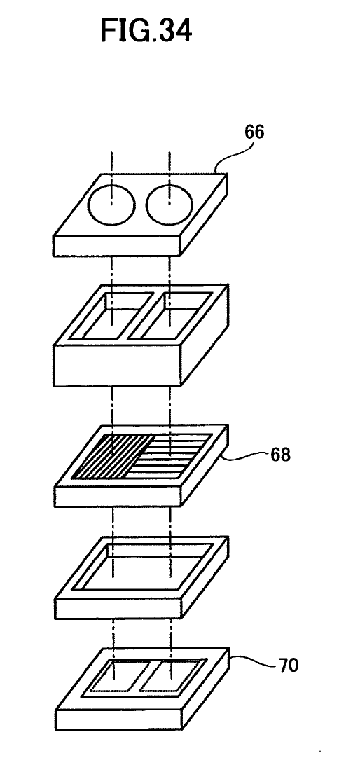

More specifically, as shown in FIG. 34, the imaging unit 12 may include a lens array 66 including multiple lenses disposed on the same substrate, a filter 68 including areas corresponding to light beams passing through the lenses of the lens array 66, and an image sensor 70 including imaging areas that receive the light beams passing through the corresponding areas of the filter 68 and generate images of an object. The filter 68 includes at least two polarization regions having orthogonal transmission axes, and one of the imaging areas of the image sensor 70 generates a vertically-polarized image and the other one of the imaging areas generates a horizontally-polarized image.

### [Exemplary Configuration 4]

With this configuration, an image is formed by one imaging lens (or multiple lenses arranged on the same axis), the image is separated into a vertically-polarized image and a horizontally-polarized image, and a polarization ratio image is generated from the vertically-polarized image and the horizontally-polarized image.

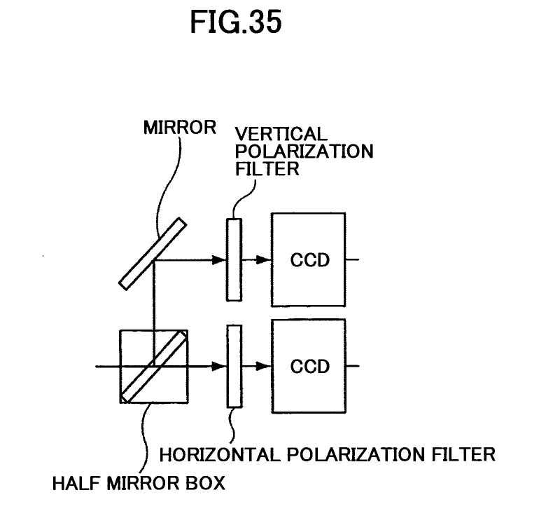

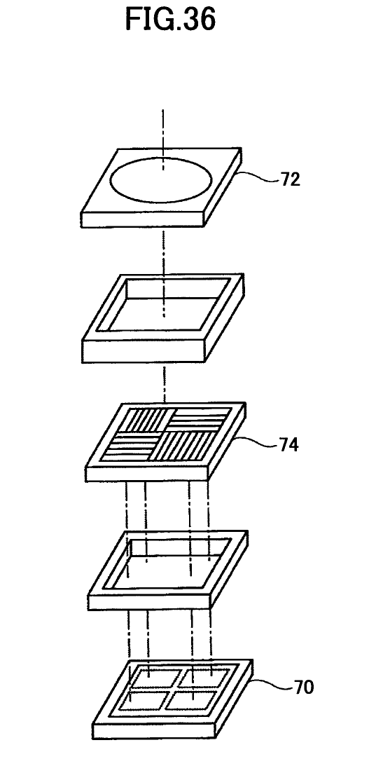

For example, as shown in FIG. 35, the imaging unit 12 may include a half-mirror box with 1:1 transmittance, a mirror, a vertical polarization filter, a horizontal polarization filter, a CCD for obtaining a field-of-view image via the vertical polarization filter, and a CCD for obtaining a field-of-view image via the horizontal polarization filter.

Although the configuration 2 makes it possible to obtain a vertically-polarized image and a horizontally-polarized image at the same time, there is parallax between the obtained images. Meanwhile, with the configuration 4, since vertically-polarized and horizontally-polarized images are obtained through the same imaging optical system (lens), there is no parallax between the obtained images. This in turn makes it possible to reduce the sizes of detection areas and to eliminate the need to compensate for the parallax.

### [Exemplary Configuration 5]

In the configuration 5, the half mirror of the configuration 4 is replaced with a polarization beam splitter. A polarization beam splitter is a prism that reflects horizontally-polarized light and transmits vertically-polarized light. Using such a prism eliminates the need to provide a vertical polarization filter and a horizontal polarization filter and thereby makes it possible to simplify the optical system and to improve light use efficiency.

### [Exemplary Configuration 6]

As shown in FIG. 36, the imaging unit 12 may include one imaging lens 72 (or multiple lenses arranged on the same axis) and a segmented filter 74 including polarizer regions that transmit only vertically-polarized light and polarizer regions that transmit only horizontally-polarized light. The filter 74 includes polarization regions with clear boundaries and may be implemented by a wire-grid polarizer made of a finely-patterned metal structure or an auto-cloned photonic crystal polarizer.

The configurations 4 and 5 use a half mirror or a prism to separate an image into a vertically-polarized image and a horizontally-polarized image and therefore require two light-receiving devices. Therefore, the configurations 4 and 5 increase the size of the optical system and the size of the imaging unit 12. Meanwhile, with the configuration 6, it is possible to obtain a vertically-polarized image and a horizontally-polarized image using an optical system that is arranged on the same axis as the imaging lens.

### [Exemplary Configuration 7]

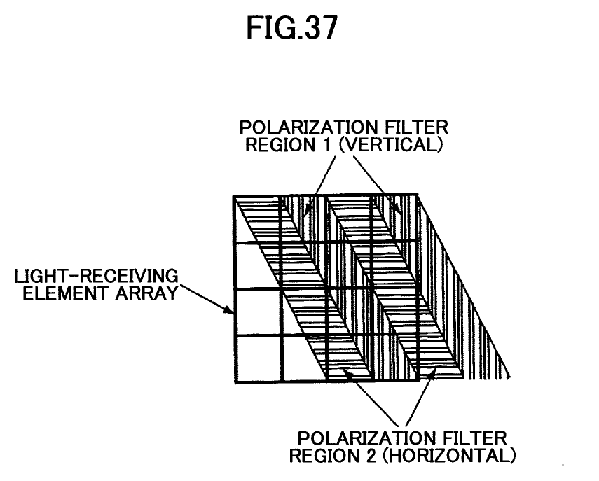

Polarizer regions of a segmented filter may not correspond one to one to the pixels of the light-receiving device. In FIG. 37, vertical and horizontal rows of squares indicate light-receiving elements constituting a light-receiving element array and two-types of diagonal strips indicate vertical and horizontal polarization filter regions. Each filter region has a width corresponding to the width of one pixel, i.e., one light-receiving element. The boundary line between the filter regions has an inclination of 2. That is, each diagonal strip is inclined such that a shift of one pixel in the horizontal direction corresponds to a shift of two pixels in the vertical direction. Combining this special filter arrangement pattern with signal processing makes it possible to produce a filtered image as a whole even when the light-receiving element array and the segmented filter are not aligned accurately and thereby makes it possible to provide a low-cost imaging device.

The imaging unit 12 as described above is preferably configured to obtain an image of a scene in real time. The obtained image is input to the image processing unit 26.

The polarization camera 12 is mounted on a vehicle and used as an imaging unit. The polarization camera 12 takes an image of the appearance (a scene in front of the vehicle in the running direction, i.e., a front view) of a road on which the vehicle is running and obtains a vertically-polarized component (hereafter called S-component), a horizontally-polarized component (hereafter called P-component), and raw polarization image data including the S-component and the P-component.

The obtained horizontally-polarized image data are stored in the memory 1 and the obtained vertically-polarized image data are stored in the memory 2.

The horizontally-polarized image data and the vertically-polarized image data are sent to the monochrome luminance information processing unit 14 used as a monochrome luminance information calculation unit and the polarization ratio information processing unit 16 used as a polarization ratio image generating unit. The polarization ratio information processing unit 16 calculates polarization ratios based on the P-component and the S-component and generates a polarization ratio image.

The monochrome luminance information processing unit 14 generates a monochrome luminance image based on the P-component and the S-component and calculates luminance information indicating luminance levels of pixels of the generated monochrome luminance image.

The polarization ratio information processing unit 16 calculates polarization ratio information indicating polarization ratios using the formula 2 above and thereby obtains polarization ratio information image data.

The monochrome luminance information processing unit 14 generates monochrome luminance information image data using the formula 3 above.

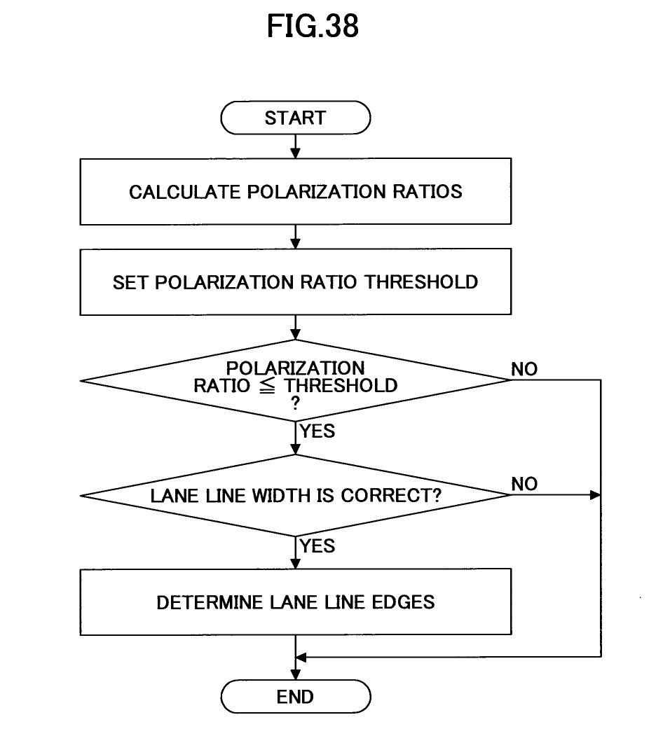

FIG. 38 is a flowchart showing a process of detecting lane line candidate points.

The lane line candidate point detection unit 36 detects candidate points indicating possible lane line edges (lane line candidate points) based on the polarization ratio information. A lane line may indicate any type of line (e.g., solid line, dotted line, dashed line, or double line) of any color (e.g., white line or yellow line) partitioning a road or traffic lanes. The lane line detection unit 40 detects lane lines on a road surface based on the polarization ratio information.

The road surface of a normal road made of asphalt is black and a white line is formed on the black road surface. The polarization ratio of the white line is close to zero. Therefore, the polarization ratio of the white line is sufficiently smaller than the polarization ratios of other parts of the road and the white line can be detected by determining a part of the road with a polarization ratio less than or equal to a predetermined value.

As shown in FIG. 38, polarization ratios of an image of a road surface in front of the vehicle are calculated based on the P-polarized component and the S-polarized component. Pixels on each scan line are processed sequentially from the center to the right and left ends of the image. The polarization ratios of pixels are compared with a predetermined polarization ratio threshold to detect lane line candidate points.

Next, a lane line width is calculated based on the detected lane line candidate points and whether the calculated white line width is within a predetermined range is determined. If the calculated white line width is within the predetermined range, the lane line candidate points are determined as white line edges on the road surface. The contrast in the polarization ratio between the lane line and other parts of the road surface in an upper part of an image is different from that in a lower part of the image.

Therefore, one frame of image is divided into an upper area and a lower area and in the step of setting the polarization ratio threshold, different polarization ratio thresholds are set for the upper area and the lower area.

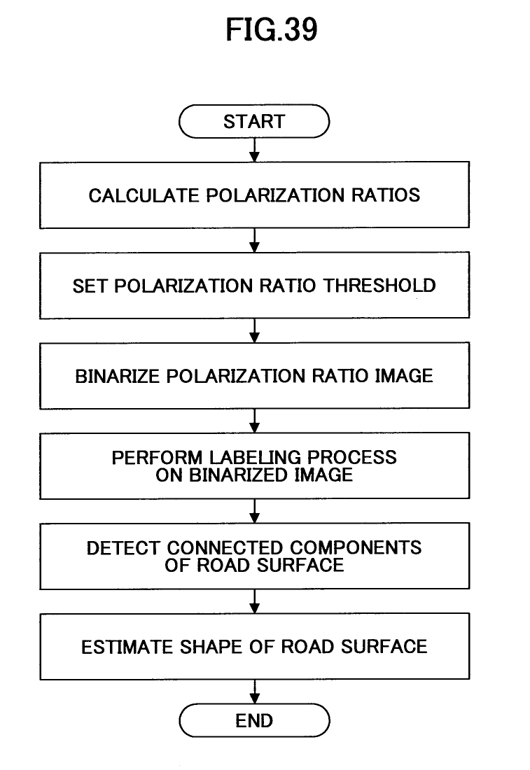

FIG. 39 is a flowchart showing a process performed by the road surface shape estimation unit 34.

The road surface shape estimation unit 34 estimates the shape of a road surface using the polarization ratio image.

First, polarization ratios of the polarization ratio image are calculated and a polarization threshold is set.

The polarization ratio image is binarized based on the polarization ratio threshold. Characteristics of connected components in the binarized polarization ratio image are studied by a labeling process and the connected components with the characteristics of the road surface are detected. Then, the shape of the road surface is estimated based on the detected connected components with the characteristics of the road surface.

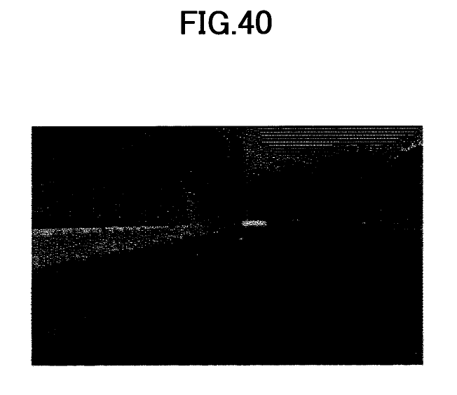

In FIG. 40, right and left black lines indicate a road surface area obtained based on the shape of the road surface.

The lane line search area determining unit 38 determines lane line search areas based on the width and the inclination of the road surface (the distance between right and left black lines and the inclinations of the black lines). The lane line search areas are in the road surface area.

If no lane line is detected in the lane line search areas, the threshold of a parameter for detecting lane line edge points is lowered and the lane line edge points are searched for again in the lane line search areas.

The lane line detection unit 40 obtains approximate curves of detected lane line edge points in the lane line search areas by shape approximation. For example, the least-squares method, the Hough transformation, or a model equation may be used for shape approximation. When obtaining the approximate curves by shape approximation, higher weights are given to reliable white line edge points and road edge points that are detected in a lower part of the road image (or screen).

With this method, even if lane line edge points are detected incorrectly in an upper part of the road image, it is possible to appropriately identify a lane line as long as lane line edge points are detected correctly in a lower part of the road image.

The detection results may be used for vehicle control or used to display a white line and a road edge on a display in an easily-viewable manner for the driver.

Thus, in this embodiment, lane line candidate points and a road surface area are detected based on a polarization ratio image, lane line search areas are determined based on the detected lane line candidate points and the road surface area, and lane lines are detected in the lane line search areas. This method makes it possible to accurately detect a white line even when the contrast of a luminance image is low and thereby makes it possible to prevent misidentification of a road shoulder or a white wall as a white line.

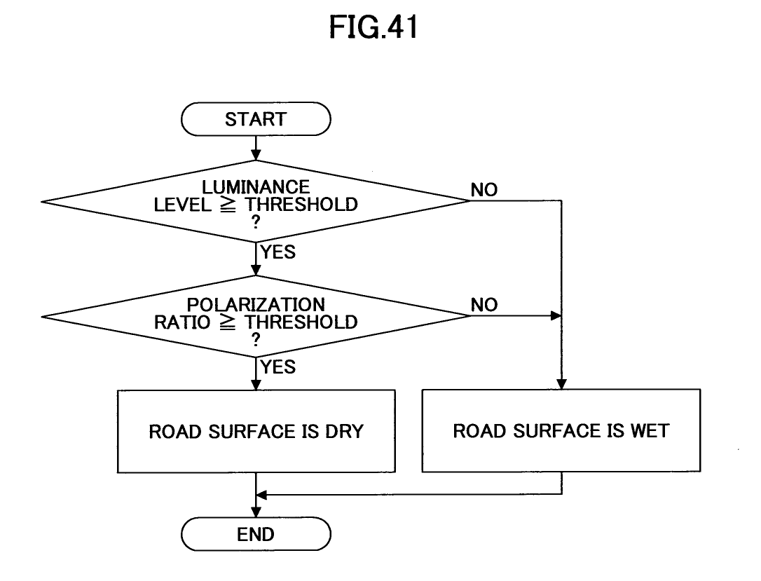

FIG. 41 is a flowchart showing a process of determining the condition of a road surface.

Luminance levels of pixels of a monochrome luminance image of a road surface area other than white lines are detected and compared with a predetermined luminance threshold. If the luminance levels are less than the luminance threshold, it is determined that the road surface area is wet.

If the luminance levels are greater than or equal to the luminance threshold, polarization ratios of pixels of a polarization ratio image of the same road surface area are compared with a predetermined polarization ratio threshold. If the polarization ratios are less than the polarization ratio threshold, it is determined that the road surface area is wet. Meanwhile, If the polarization ratios are greater than or equal to the polarization ratio threshold, it is determined that the road surface area is dry. The luminance threshold and the polarization ratio threshold may be determined based on experimental results.

This method makes it possible to estimate the weather and to estimate whether the road surface is wet or dry. Sample polarization ratio images and monochrome luminance images of various road surface conditions are studied, and an appropriate parameter for binarization and a threshold of the parameter are determined according to the road surface condition based on the study results.

The area storage unit 50 stores previously detected lane lines and lane line search areas. When detecting lane lines and lane line search areas in real time, it is determined that the detected lane lines and lane line search areas are reliable if similar lane lines and lane line search areas are found in one or more previously-obtained images. Based on the positions of lane line search areas in a previous frame, lane line edge points are searched for in the next frame and approximate curves are obtained.

If no lane line edge is detected in five frames of images, the search is started again from the center of a scan line in the lower part of an image.

As described above, an aspect of the present invention makes it possible to provide an imaging device with a simple configuration that can accurately detect white lines, road edges (or roadside structures), and boundaries of a road surface regardless of the imaging environment (e.g., dark or bright, fine or cloudy weather, etc.) and to provide appropriate information for driver assistance and vehicle control.

An aspect of the present invention makes it possible to accurately detect white lines on a road surface by using polarization ratios of light reflected from the road surface.

According to an aspect of the present invention, white lines are detected based on the shape of a road surface estimated based on a polarization ratio image of the road surface. This method makes it possible to prevent misidentification of a road shoulder or a ditch as a white line.

An embodiment of the present invention provides an object detection device obtaining an image of a detection target in an imaging area and detecting an image area corresponding to the detection target in the obtained image. The object detection device includes an imaging unit receiving first polarized light and second polarized light included in reflected light from an object in the imaging area and obtaining a first polarization image of the first polarized light and a second polarization image of the second polarized light, the first polarized light and the second polarized light having different polarization directions; a luminance calculation unit dividing each of the first and second polarization images into processing areas and calculating a combined luminance level indicating a sum of luminance levels of the first and second polarization images for each of the processing areas; a polarization ratio calculation unit calculating a polarization ratio indicating a ratio of a difference between the luminance levels of the first and second polarization images to the combined luminance level for each of the processing areas; a polarization ratio image generating unit generating a polarization ratio image based on the polarization ratios of all the processing areas calculated by the polarization ratio calculation unit; a lane line candidate point detection unit detecting lane line candidate points of a lane line partitioning traffic lanes on a road surface based on the polarization ratios; a road surface shape estimation unit estimating a shape of the road surface based on the polarization ratios; a lane line search area determining unit determining a lane line search area based on the estimated shape of the road surface; and a lane line detection unit detecting the lane line based on the lane line candidate points in the determined lane line search area.

The lane line search area determining unit may be configured to determine the lane line search area based on the inclination and the width of the road surface estimated by the road surface shape estimation unit.

When the lane line is not detected in the lane line search area, the lane line detection unit may lower a polarization ratio threshold used to detect the lane line in the lane line search area.

The road surface shape estimation unit may be configured to binarize the polarization ratio image based on a threshold of a predetermined parameter, perform a labeling process on the binarized polarization ratio image to detect connected components having characteristics of the road surface, and estimate the shape of the road surface based on the detected connected components.

The object detection device may also include a condition determining unit determining a condition in the imaging area based on at least one of the polarization ratios calculated by the polarization ratio calculation unit and the combined luminance levels calculated by the luminance calculation unit; and a parameter threshold determining unit determining the threshold of the parameter according to the condition determined by the condition determining unit.

The parameter threshold determining unit may be configured to study at least one of the polarization ratios and the combined luminance levels calculated previously for different conditions and to determine the threshold of the parameter based on the study results.

The object detection device may also include a shape information storage unit storing shape information indicating shapes of the detection target in an image previously obtained by the imaging unit. Each of the lane line detection unit and the road surface shape estimation unit may be configured to detect adjacent processing areas corresponding to the detection target, to determine whether a shape formed by the detected processing areas is similar to one of the shapes stored in the shape information storage unit by shape approximation, and to determine the detected processing areas as the image area of the detection target if the shape formed by the detected processing areas is similar to one of the shapes stored in the shape information storage unit.

Each of the line detection unit and the road surface shape estimation unit may be configured to divide each of the first polarization image and the second polarization image into two or more regions according to imaging distances and in the shape approximation, to give higher weights to the processing areas detected in one of the regions at a shorter imaging distance compared with weights given to the processing areas detected in another one of the regions at a longer imaging distance.

The object detection device may further include a detection result storage unit storing previous detection results, and the object detection device may be configured to detect the image area corresponding to the detection target also using the previous detection results stored in the detection result storage unit.

The present invention is not limited to the specifically disclosed embodiments, and variations and modifications may be made without departing from the scope of the present invention.

The present application is based on Japanese Priority Application No. 2009-295838 filed on Dec. 25, 2009 and Japanese Priority Application No. 2010-254213 filed on Nov. 12, 2010, the entire contents of which are hereby incorporated herein by reference.

1. An imaging device, comprising:
an imaging unit mounted on a vehicle and obtaining a vertically-polarized image and a horizontally-polarized image of a road surface on which the vehicle is running;
a polarization ratio image generating unit generating a polarization ratio image and calculating polarization ratio information indicating polarization ratios of pixels of the polarization ratio image based on the vertically-polarized image and the horizontally-polarized image; and
a roadside structure detection unit detecting a planar line formed on and partitioning the road surface and/or a roadside structure located adjacent to and at an angle with the road surface based on the polarization ratio information of the polarization ratio image.

2. The imaging device as claimed in claim 1, wherein the roadside structure detection unit scans the polarization ratio image and detects the roadside structure based on the polarization ratio information of each of scan lines.

3. The imaging device as claimed in claim 2, wherein the roadside structure detection unit calculates differences between the polarization ratios of the pixels on each of the scan lines and a reference polarization ratio of a reference pixel on the same scan line and compares the differences with a predetermined threshold to detect the roadside structure.

4. The imaging device as claimed in claim 3, further comprising:
a luminance information calculation unit generating a luminance image and calculating luminance information indicating luminance levels of pixels of the luminance image based on the vertically-polarized image and the horizontally-polarized image; and
a line detection unit detecting the line based on the calculated luminance information,
wherein the roadside structure detection unit determines the reference pixel relative to the detected line, sets a polarization ratio of the reference pixel as the reference polarization ratio, and determines the threshold based on the reference polarization ratio.

5. The imaging device as claimed in claim 4,
wherein when the line is not detected, the roadside structure detection unit determines the reference pixel relative to a line detected in a previously generated polarization ratio image.

6. The imaging device as claimed in claim 4,
wherein when the line ends in a middle in a running direction of the vehicle, the roadside structure detection unit determines the reference pixel relative to a line detected in a previously generated polarization ratio image for an area of the road surface where the line is not present.

7. The imaging device as claimed in claim 6,
wherein when the line detected in the previously generated polarization ratio image also ends in a middle in the running direction of the vehicle or no line is detected in the previously generated polarization ratio image, the roadside structure detection unit determines the reference pixel relative to an extension of the line ending in the middle in the running direction of the vehicle for the area of the road surface where the line is not present.

8. The imaging device as claimed in claim 4, wherein when the line is not detected, the roadside structure detection unit uses a polarization ratio of a pixel at a center of the road surface as the reference polarization ratio.

9. The imaging device as claimed in claim 4, wherein the line detection unit divides the luminance image into an upper area and a lower area in a running direction of the vehicle, sets different luminance thresholds for the upper area and the lower area, and detects the line by comparing the luminance levels of the pixels in each of the upper area and the lower area with the corresponding one of the luminance thresholds.

10. The imaging device as claimed in claim 4, wherein the line detection unit detects line candidate points based on the luminance information, calculates a line width based on the detected line candidate points, and determines the line candidate points as edges of the line if the calculated line width is within a predetermined range.

11-15. (canceled)

16. A method of detecting an appearance of a road surface, comprising the steps of:
obtaining a vertically-polarized image and a horizontally-polarized image of the road surface on which a vehicle is running;
generating a polarization ratio image and calculating polarization ratio information indicating polarization ratios of pixels of the polarization ratio image based on the vertically-polarized image and the horizontally-polarized image; and
detecting a planar line formed on and partitioning the road surface and/or a roadside structure located adjacent to and at an angle with the road surface based on the polarization ratio information of the polarization ratio image.

17. An object detection device obtaining an image of a detection target in an imaging area and detecting an image area corresponding to the detection target in the obtained image, comprising:
an imaging unit receiving first polarized light and second polarized light included in reflected light from an object in the imaging area and obtaining a first polarization image of the first polarized light and a second polarization image of the second polarized light, the first polarized light and the second polarized light having different polarization directions;
a luminance calculation unit dividing each of the first and second polarization images into processing areas and calculating a combined luminance level indicating a sum of luminance levels of the first and second polarization images for each of the processing areas;
a polarization ratio calculation unit calculating a polarization ratio indicating a ratio of a difference between the luminance levels of the first and second polarization images to the combined luminance level for each of the processing areas;
a polarization ratio image generating unit generating a polarization ratio image based on the polarization ratios of all the processing areas calculated by the polarization ratio calculation unit;
a lane line candidate point detection unit detecting lane line candidate points of a lane line partitioning traffic lanes on a road surface based on the polarization ratios;
a road surface shape estimation unit estimating a shape of the road surface based on the polarization ratios;
a lane line search area determining unit determining a lane line search area based on the estimated shape of the road surface; and
a lane line detection unit detecting the lane line based on the lane line candidate points in the determined lane line search area.

18. The object detection device as claimed in claim 17, wherein the lane line search area determining unit determines the lane line search area based on an inclination and a width of the road surface estimated by the road surface shape estimation unit.

19. The object detection device as claimed in claim 17, wherein when the lane line is not detected in the lane line search area, the lane line detection unit lowers a polarization ratio threshold used to detect the lane line in the lane line search area.

20. The object detection device as claimed in claim 17, wherein the road surface shape estimation unit binarizes the polarization ratio image based on a threshold of a predetermined parameter, performs a labeling process on the binarized polarization ratio image to detect connected components having characteristics of the road surface, and estimates the shape of the road surface based on the detected connected components.

21. The object detection device as claimed in claim 20, further comprising:
a condition determining unit determining a condition in the imaging area based on at least one of the polarization ratios calculated by the polarization ratio calculation unit and the combined luminance levels calculated by the luminance calculation unit; and
a parameter threshold determining unit determining the threshold of the parameter according to the condition determined by the condition determining unit.

22. The object detection device as claimed in claim 21, wherein the parameter threshold determining unit studies at least one of the polarization ratios and the combined luminance levels calculated previously for different conditions and determines the threshold of the parameter based on the study results.

23. The object detection device as claimed in claim 17, further comprising:
a shape information storage unit storing shape information indicating shapes of the detection target in an image previously obtained by the imaging unit, wherein
each of the lane line detection unit and the road surface shape estimation unit is configured to detect adjacent processing areas corresponding to the detection target, to determine whether a shape formed by the detected processing areas is similar to one of the shapes stored in the shape information storage unit by shape approximation, and to determine the detected processing areas as the image area of the detection target if the shape formed by the detected processing areas is similar to one of the shapes stored in the shape information storage unit.

24. The object detection device as claimed in claim 23, wherein each of the line detection unit and the road surface shape estimation unit is configured to divide each of the first polarization image and the second polarization image into two or more regions according to imaging distances and in the shape approximation, to give higher weights to the processing areas detected in one of the regions at a shorter imaging distance compared with weights given to the processing areas detected in another one of the regions at a longer imaging distance.

25. The object detection device as claimed in claim 17, further comprising:
a detection result storage unit storing previous detection results,
wherein the object detection device is configured to detect the image area corresponding to the detection target also using the previous detection results stored in the detection result storage unit.
